(19) United States
(12) Patent Application Publication
(10) Pub. No.: US 2026/0165315 A1
(43) Pub. Date: Jun. 18, 2026

(54) AGROCHEMICAL COMPOSITIONS AND METHODS OF MAKING AND USING THE SAME

(71) Applicant: Provivi, Inc., Santa Moica, CA (US)

(72) Inventor: Aditya MENON, Santa Monica, CA (US)

(21) Appl. No.: 19/140,866

(22) PCT Filed: Dec. 21, 2023
(86) PCT No.: PCT/US2023/085367

§ 371 Date: Jun. 18, 2025

Related U.S. Application Data
(60) Provisional application No. 63/476,841, filed on Dec. 22, 2022.

(51) Int. Cl. A01N 25/10; A01N 25/22; A01N 25/34; A01N 37/16; A01P 17/00

(52) U.S. Cl. CPC A01N 25/10; A01N 25/22; A01N 25/34; A01N 37/16; A01P 17/00

(57) ABSTRACT

This disclosure provides agrochemical compositions that release active ingredients and methods of manufacturing and using the same. In embodiments, the present disclosure relates to agrochemical compositions comprising controlled-release semiochemical compositions contained within a crosslinked matrix. In embodiments, the active ingredient comprises a pheromone.

### CROSS-REFERENCE TO RELATED APPLICATIONS

The present application claims priority to U.S. Provisional Patent Application No. 63/476,841 filed Dec. 22, 2022, and which is hereby incorporated by reference in its entirety.

### BACKGROUND

The world's population is dramatically increasing and concomitant with that rise in population is an urgent need to meet the burgeoning population's food demands. Traditionally, modern agriculture has relied upon chemistry to help control pest populations and ensure steady and predictable food yields. However, there is an increasing recognition that agricultural chemicals may have a detrimental effect upon the environment. Thus, there is an urgent demand for a more sustainable way to meet the world's food requirements and ultimately transition chemistry-based row crop agriculture to a more sustainable and environmentally friendly paradigm.

### SUMMARY OF THE INVENTION

The present disclosure provides agricultural compositions that release active ingredients such as pheromones, which are able to replace detrimental agriculture chemistries.

In embodiments, the present disclosure provides controlled-release agrochemical compositions comprising: a crosslinked matrix; and a semiochemical composition contained within the crosslinked matrix.

### BRIEF DESCRIPTION OF THE DRAWINGS

FIG. 1 shows a method for making a crosslinked matrix of the controlled-release agrochemical compositions of the present disclosure.

FIGS. 2-4 show the relative stability of controlled-release agrochemical compositions comprising a crosslinked matrix (G4 and G5) of the present disclosure compared to agrochemical compositions that do not include a crosslinked matrix (G1-G6).

FIGS. 5-7 show the relative stability of controlled-release agrochemical compositions comprising a crosslinked matrix (G4 and G5) of the present disclosure compared to agrochemical compositions that do not include a crosslinked matrix (G3).

FIG. 8 shows FAW blend release properties for PCL-polyurethane matrices of the present disclosure.

FIGS. 9-11 show male moth suppression rates using controlled-release agrochemical compositions comprising a crosslinked matrix of the present disclosure as compared to agrochemical compositions that do not include a crosslinked matrix.

### DETAILED DESCRIPTION OF THE INVENTION

### Definitions

The term “about” when immediately preceding a numerical value means±up to 10% of the numerical value. For example, “about” a numerical value means±up to 10% of the numerical value, in embodiments, ±up to 10%, ±up to 9%, ±up to 8%, ±up to 7%, ±up to 6%, ±up to 5%, ±up to 4%, ±up to 3%, ±up to 2%, ±up to 1%, +up to less than 1%, or any other value or range of values therein.

Throughout the present disclosure, numerical ranges are provided for certain quantities. These ranges comprise all subranges therein. Thus, the range “from 50 to 80” includes all possible ranges therein (e.g., 51-79, 52-78, 53-77, 54-76, 55-75, 60-70, etc.). Furthermore, all values within a given range may be an endpoint for the range encompassed thereby (e.g., the range 50-80 includes the ranges with endpoints such as 55-80, 50-75, etc.).

The term “effective amount” refers to an amount of an agrochemical composition that, when applied to an area (for example, a field), is capable of achieving an intended result (such as controlling a population of one or more pests in a field). The actual amount which comprises the “effective amount” will vary depending on a number of conditions including, but not limited to, the type and level of infestation; the type of agrochemical composition used; the concentration of the active ingredient(s); how the composition is provided, for example, the type of composition used (e.g., granules, flakes, and dispensers); the type of area to be treated; the length of time the method is to be used for; and environmental factors such as temperature, wind speed and direction, rainfall and humidity in the area where the agrochemical composition is applied. A skilled practitioner can readily determine the appropriate amount using methods known in the agricultural arts.

All weight percentages (i.e., “% by weight” and “wt. %” and w/w) referenced herein, unless otherwise indicated, are relative to the total weight of the mixture or composition, as the case may be.

### Active Ingredients

The agrochemical compositions of the present disclosure comprise an active ingredient. Persons skilled in the art can select the type and amount an active ingredient, or mixture of active ingredients (such as a pheromone), that, when used in an agrochemical composition of the present disclosure (infra), is effective for a particular agricultural application (such as the control of Spodoptera frugiperda (fall armyworm), Chilo Suppresalis (striped stem borer), Scirpohoga incetulus (yellowstem borer), Chrysodexis includens (soybean looper), etc.). The following active ingredients are non-limiting examples of active ingredients that may be used, alone or in combination, in the agrochemical compositions of the present disclosure.

In embodiments, the active ingredient comprises a semiochemical. In embodiments, the semiochemical comprises allomone, a kairomone, a pheromone, or mixtures thereof.

In embodiments, the semiochemical comprises a pheromone. Most pheromones comprise a hydrocarbon skeleton with the terminal hydrogen substituted by a functional group (Ryan MF (2002). Insect Chemoreception. Fundamental and Applied. Kluwer Academic Publishers). The presence of one or more double bonds, generated by the loss of hydrogens from adjacent carbons, determines the degree of unsaturation of the molecule and alters the designation of a hydrocarbon from -ane (no multiple bonds) to -ene. The presence of two and three double bonds is indicated by ending the name with -diene and -triene, respectively. The position of each double bond is represented by a numeral corresponding to that of the carbon from which it begins, with each carbon numbered from that attached to the functional group. The carbon to which the functional group is attached is designated -1-. Pheromones may have, but are not limited to, hydrocarbon chain lengths numbering 10 (deca-), 12 (dodeca-), 14 (tetradeca-), 16 (hexadeca-), or 18 (octadeca-) carbons long. The presence of a double bond has another effect. It precludes rotation of the molecule by fixing it in one of two possible configurations, each representing geometric isomers that are different molecules. These are designated either E (from the German word Entgegen, opposite) or Z (Zusammen, together), when the carbon chains are connected on the opposite (trans) or same (cis) side, respectively, of the double bond.

In embodiments, the pheromone comprises one or more of a sex, trail, territory, or aggregation pheromone.

In embodiments, sex pheromones include the C₆-C₂₀ pheromones described in Table 1.

In embodiments, the compositions of the present disclosure comprise a sex pheromone described in Table 1. In embodiments, the compositions of the present disclosure comprise a mixture of sex pheromone in Table 1.

TABLE 1
Sex Pheromones of the Present Disclosure

| Name | Name |
|---|---|
| (E)-2-Decen-1-ol | (Z,E)-9,11-Tetradecadien-1-ol |
| (E)-2-Decenyl acetate | (Z,E)-9,11-Tetradecadienyl acetate |
| (E)-2-Decenal | (Z,E)-9,11-Tetradecadienal |
| (Z)-2-Decen-1-ol | (Z,Z)-9,11-Tetradecadien-1-ol |
| (Z)-2-Decenyl acetate | (Z,Z)-9,11-Tetradecadienyl acetate |
| (Z)-2-Decenal | (Z,Z)-9,11-Tetradecadienal |
| (E)-3-Decen-1-ol | (E,E)-9,12-Tetradecadienyl acetate |
| (Z)-3-Decenyl acetate | (Z,E)-9,12-Tetradecadien-1-ol |
| (Z)-3-Decen-1-ol | (Z,E)-9,12-Tetradecadienyl acetate |
| (Z)-4-Decen-1-ol | (Z,E)-9,12-Tetradecadienal |
| (E)-4-Decenyl acetate | (Z,Z)-9,12-Tetradecadien-1-ol |
| (Z)-4-Decenyl acetate | (Z,Z)-9,12-Tetradecadienyl acetate |
| (Z)-4-Decenal | (E,E)-10,12-Tetradecadien-1-ol |
| (E)-5-Decen-1-ol | (E,E)-10,12-Tetradecadienyl acetate |
| (E)-5-Decenyl acetate | (E,E)-10,12-Tetradecadienal |
| (Z)-5-Decen-1-ol | (E,Z)-10,12-Tetradecadienyl acetate |
| (Z)-5-Decenyl acetate | (Z,E)-10,12-Tetradecadienyl acetate |
| (Z)-5-Decenal | (Z,Z)-10,12-Tetradecadien-1-ol |
| (E)-7-Decenyl acetate | (Z,Z)-10,12-Tetradecadienyl acetate |
| (Z)-7-Decenyl acetate | (E,Z,Z)-3,8,11-Tetradecatrienyl acetate |
| (E)-8-Decen-1-ol | (E)-8-Pentadecen-1-ol |
| (E,E)-2,4-Decadienal | (E)-8-Pentadecenyl acetate |
| (E,Z)-2,4-Decadienal | (Z)-8-Pentadecen-1-ol |
| (Z,Z)-2,4-Decadienal | (Z)-8-Pentadecenyl acetate |
| (E,E)-3,5-Decadienyl acetate | (Z)-9-Pentadecenyl acetate |
| (Z,E)-3,5-Decadienyl acetate | (E)-9-Pentadecenyl acetate |
| (Z,Z)-4,7-Decadien-1-ol | (Z)-10-Pentadecenyl acetate |
| (Z,Z)-4,7-Decadienyl acetate | (Z)-10-Pentadecenal |
| (E)-2-Undecenyl acetate | (E)-12-Pentadecenyl acetate |
| (E)-2-Undecenal | (Z)-12-Pentadecenyl acetate |
| (Z)-5-Undecenyl acetate | (Z,Z)-6,9-Pentadecadien-1-ol |
| (Z)-7-Undecenyl acetate | (Z,Z)-6,9-Pentadecadienyl acetate |
| (Z)-8-Undecenyl acetate | (Z,Z)-6,9-Pentadecadienal |
| (Z)-9-Undecenyl acetate | (E,E)-8,10-Pentadecadienyl acetate |
| (E)-2-Dodecenal | (E,Z)-8,10-Pentadecadien-1-ol |
| (Z)-3-Dodecen-1-ol | (E,Z)-8,10-Pentadecadienyl acetate |
| (E)-3-Dodecenyl acetate | (Z,E)-8,10-Pentadecadienyl acetate |
| (Z)-3-Dodecenyl acetate | (Z,Z)-8,10-Pentadecadienyl acetate |
| (E)-4-Dodecenyl acetate | (E,Z)-9,11-Pentadecadienal |
| (E)-5-Dodecen-1-ol | (Z,Z)-9,11-Pentadecadienal |
| (E)-5-Dodecenyl acetate | (Z)-3-Hexadecenyl acetate |
| (Z)-5-Dodecen-1-ol | (E)-5-Hexadecen-1-ol |
| (Z)-5-Dodecenyl acetate | (E)-5-Hexadecenyl acetate |
| (Z)-5-Dodecenal | (Z)-5-Hexadecen-1-ol |
| (E)-6-Dodecen-1-ol | (Z)-5-Hexadecenyl acetate |
| (Z)-6-Dodecenyl acetate | (E)-6-Hexadecenyl acetate |
| (E)-6-Dodecenal | (E)-7-Hexadecen-1-ol |
| (E)-7-Dodecen-1-ol | (E)-7-Hexadecenyl acetate |
| (E)-7-Dodecenyl acetate | (E)-7-Hexadecenal |
| (E)-7-Dodecenal | (Z)-7-Hexadecen-1-ol |
| (Z)-7-Dodecen-1-ol | (Z)-7-Hexadecenyl acetate |
| (Z)-7-Dodecenyl acetate | (Z)-7-Hexadecenal |
| (Z)-7-Dodecenal | (E)-8-Hexadecenyl acetate |
| (E)-8-Dodecen-1-ol | (E)-9-Hexadecen-1-ol |
| (E)-8-Dodecenyl acetate | (E)-9-Hexadecenyl acetate |
| (E)-8-Dodecenal | (E)-9-Hexadecenal |
| (Z)-8-Dodecen-1-ol | (Z)-9-Hexadecen-1-ol |
| (Z)-8-Dodecenyl acetate | (Z)-9-Hexadecenyl acetate |
| (E)-9-Dodecen-1-ol | (Z)-9-Hexadecenal |
| (E)-9-Dodecenyl acetate | (E)-10-Hexadecen-1-ol |
| (E)-9-Dodecenal | (E)-10-Hexadecenal |
| (Z)-9-Dodecen-1-ol | (Z)-10-Hexadecenyl acetate |
| (Z)-9-Dodecenyl acetate | (Z)-10-Hexadecenal |
| (Z)-9-Dodecenal | (E)-11-Hexadecen-1-ol |
| (E)-10-Dodecen-1-ol | (E)-11-Hexadecenyl acetate |
| (E)-10-Dodecenyl acetate | (E)-11-Hexadecenal |
| (E)-10-Dodecenal | (Z)-11-Hexadecen-1-ol |
| (Z)-10-Dodecen-1-ol | (Z)-11-Hexadecenyl acetate |
| (Z)-10-Dodecenyl acetate | (Z)-11-Hexadecenal |
| (E,Z)-3,5-Dodecadienyl acetate | (Z)-12-Hexadecenyl acetate |
| (Z,E)-3,5-Dodecadienyl acetate | (Z)-12-Hexadecenal |
| (Z,Z)-3,6-Dodecadien-1-ol | (E)-14-Hexadecenal |
| (E,E)-4,10-Dodecadienyl acetate | (Z)-14-Hexadecenyl acetate |
| (E,E)-5,7-Dodecadien-1-ol | (E,E)-1,3-Hexadecadien-1-ol |
| (E,E)-5,7-Dodecadienyl acetate | (E,Z)-4,6-Hexadecadien-1-ol |
| (E,Z)-5,7-Dodecadien-1-ol | (E,Z)-4,6-Hexadecadienyl acetate |
| (E,Z)-5,7-Dodecadienyl acetate | (E,Z)-4,6-Hexadecadienal |
| (E,Z)-5,7-Dodecadienal | (E,Z)-6,11-Hexadecadienyl acetate |
| (Z,E)-5,7-Dodecadien-1-ol | (E,Z)-6,11-Hexadecadienal |
| (Z,E)-5,7-Dodecadienyl acetate | (Z,Z)-7,10-Hexadecadien-1-ol |
| (Z,E)-5,7-Dodecadienal | (Z,Z)-7,10-Hexadecadienyl acetate |
| (Z,Z)-5,7-Dodecadienyl acetate | (Z,E)-7,11-Hexadecadien-1-ol |
| (Z,Z)-5,7-Dodecadienal | (Z,E)-7,11-Hexadecadienyl acetate |
| (E,E)-7,9-Dodecadienyl acetate | (Z,E)-7,11-Hexadecadienal |
| (E,Z)-7,9-Dodecadien-1-ol | (Z,Z)-7,11-Hexadecadien-1-ol |
| (E,Z)-7,9-Dodecadienyl acetate | (Z,Z)-7,11-Hexadecadienyl acetate |
| (E,Z)-7,9-Dodecadienal | (Z,Z)-7,11-Hexadecadienal |
| (Z,E)-7,9-Dodecadien-1-ol | (Z,Z)-8,10-Hexadecadienyl acetate |
| (Z,E)-7,9-Dodecadienyl acetate | (E,Z)-8,11-Hexadecadienal |
| (Z,Z)-7,9-Dodecadien-1-ol | (E,E)-9,11-Hexadecadienal |
| (Z,Z)-7,9-Dodecadienyl acetate | (E,Z)-9,11-Hexadecadienyl acetate |
| (E,E)-8,10-Dodecadien-1-ol | (E,Z)-9,11-Hexadecadienal |
| (E,E)-8,10-Dodecadienyl acetate | (Z,E)-9,11-Hexadecadienal |
| (E,E)-8,10-Dodecadienal | (Z,Z)-9,11-Hexadecadienal |
| (E,Z)-8,10-Dodecadien-1-ol | (E,E)-10,12-Hexadecadien-1-ol |
| (E,Z)-8,10-Dodecadienyl acetate | (E,E)-10,12-Hexadecadienyl acetate |
| (E,Z)-8,10-Dodecadienal | (E,E)-10,12-Hexadecadienal |
| (Z,E)-8,10-Dodecadien-1-ol | (E,Z)-10,12-Hexadecadien-1-ol |
| (Z,E)-8,10-Dodecadienyl acetate | (E,Z)-10,12-Hexadecadienyl acetate |
| (Z,E)-8,10-Dodecadienal | (E,Z)-10,12-Hexadecadienal |
| (Z,Z)-8,10-Dodecadien-1-ol | (Z,E)-10,12-Hexadecadienyl acetate |
| (Z,Z)-8,10-Dodecadienyl acetate | (Z,E)-10,12-Hexadecadienal |
| (Z,E,E)-3,6,8-Dodecatrien-1-ol | (Z,Z)-10,12-Hexadecadienal |
| (Z,Z,E)-3,6,8-Dodecatrien-1-ol | (E,E)-11,13-Hexadecadien-1-ol |
| (E)-2-Tridecenyl acetate | (E,E)-11,13-Hexadecadienyl acetate |
| (Z)-2-Tridecenyl acetate | (E,E)-11,13-Hexadecadienal |
| (E)-3-Tridecenyl acetate | (E,Z)-11,13-Hexadecadien-1-ol |
| (E)-4-Tridecenyl acetate | (E,Z)-11,13-Hexadecadienyl acetate |
| (Z)-4-Tridecenyl acetate | (E,Z)-11,13-Hexadecadienal |
| (Z)-4-Tridecenal | (Z,E)-11,13-Hexadecadien-1-ol |
| (E)-6-Tridecenyl acetate | (Z,E)-11,13-Hexadecadienyl acetate |
| (Z)-7-Tridecenyl acetate | (Z,E)-11,13-Hexadecadienal |
| (E)-8-Tridecenyl acetate | (Z,Z)-11,13-Hexadecadien-1-ol |
| (Z)-8-Tridecenyl acetate | (Z,Z)-11,13-Hexadecadienyl acetate |
| (E)-9-Tridecenyl acetate | (Z,Z)-11,13-Hexadecadienal |
| (Z)-9-Tridecenyl acetate | (E,E)-10,14-Hexadecadienal |
| (Z)-10-Tridecenyl acetate | (Z,E)-11,14-Hexadecadienyl acetate |
| (E)-11-Tridecenyl acetate | (E,E,Z)-4,6,10-Hexadecatrien-1-ol |
| (Z)-11-Tridecenyl acetate | (E,E,Z)-4,6,10-Hexadecatrienyl acetate |
| (E,Z)-4,7-Tridecadienyl acetate | (E,Z,Z)-4,6,10-Hexadecatrien-1-ol |
| (Z,Z)-4,7-Tridecadien-1-ol | (E,Z,Z)-4,6,10-Hexadecatrienyl acetate |
| (Z,Z)-4,7-Tridecadienyl acetate | (E,E,Z)-4,6,11-Hexadecatrienyl acetate |
| (E,Z)-5,9-Tridecadienyl acetate | (E,E,Z)-4,6,11-Hexadecatrienal |
| (Z,E)-5,9-Tridecadienyl acetate | (Z,Z,E)-7,11,13-Hexadecatrienal |
| (Z,Z)-5,9-Tridecadienyl acetate | (E,E,E)-10,12,14-Hexadecatrienyl acetate |
| (Z,Z)-7,11-Tridecadienyl acetate | (E,E,E)-10,12,14-Hexadecatrienal |
| (E,Z,Z)-4,7,10-Tridecatrienyl acetate | (E,E,Z)-10,12,14-Hexadecatrienyl acetate |
| (E)-3-Tetradecen-1-ol | (E,E,Z)-10,12,14-Hexadecatrienal |
| (E)-3-Tetradecenyl acetate | (E,E,Z,Z)-4,6,11,13-Hexadecatetraenal |
| (Z)-3-Tetradecen-1-ol | (E)-2-Heptadecenal |
| (Z)-3-Tetradecenyl acetate | (Z)-2-Heptadecenal |
| (E)-5-Tetradecen-1-ol | (E)-8-Heptadecen-1-ol |
| (E)-5-Tetradecenyl acetate | (E)-8-Heptadecenyl acetate |
| (E)-5-Tetradecenal | (Z)-8-Heptadecen-1-ol |
| (Z)-5-Tetradecen-1-ol | (Z)-9-Heptadecenal |
| (Z)-5-Tetradecenyl acetate | (E)-10-Heptadecenyl acetate |
| (Z)-5-Tetradecenal | (Z)-11-Heptadecen-1-ol |
| (E)-6-Tetradecenyl acetate | (Z)-11-Heptadecenyl acetate |
| (Z)-6-Tetradecenyl acetate | (E,E)-4,8-Heptadecadienyl acetate |
| (E)-7-Tetradecen-1-ol | (Z,Z)-8,10-Heptadecadien-1-ol |
| (E)-7-Tetradecenyl acetate | (Z,Z)-8,11-Heptadecadienyl acetate |
| (Z)-7-Tetradecen-1-ol | (E)-2-Octadecenyl acetate |
| (Z)-7-Tetradecenyl acetate | (E)-2-Octadecenal |
| (Z)-7-Tetradecenal | (Z)-2-Octadecenyl acetate |
| (E)-8-Tetradecenyl acetate | (Z)-2-Octadecenal |
| (Z)-8-Tetradecen-1-ol | (E)-9-Octadecen-1-ol |
| (Z)-8-Tetradecenyl acetate | (E)-9-Octadecenyl acetate |
| (Z)-8-Tetradecenal | (E)-9-Octadecenal |
| (E)-9-Tetradecen-1-ol | (Z)-9-Octadecen-1-ol |
| (E)-9-Tetradecenyl acetate | (Z)-9-Octadecenyl acetate |
| (Z)-9-Tetradecen-1-ol | (Z)-9-Octadecenal (Z9-18Ald) |
| (Z)-9-Tetradecenyl acetate | (E)-11-Octadecen-1-ol |
| (Z)-9-Tetradecenal | (E)-11-Octadecenal |
| (E)-10-Tetradecenyl acetate | (Z)-11-Octadecen-1-ol |
| (Z)-10-Tetradecenyl acetate | (Z)-11-Octadecenyl acetate |
| (E)-11-Tetradecen-1-ol | (Z)-11-Octadecenal |
| (E)-11-Tetradecenyl acetate | (E)-13-Octadecenyl acetate |
| (E)-11-Tetradecenal | (E)-13-Octadecenal |
| (Z)-11-Tetradecen-1-ol | (Z)-13-Octadecen-1-ol |
| (Z)-11-Tetradecenyl acetate | (Z)-13-Octadecenyl acetate |
| (Z)-11-Tetradecenal | (Z)-13-Octadecenal |
| (E)-12-Tetradecenyl acetate | (E)-14-Octadecenal |
| (Z)-12-Tetradecenyl acetate | (E,Z)-2,13-Octadecadien-1-ol |
| (E,E)-2,4-Tetradecadienal | (E,Z)-2,13-Octadecadienyl acetate |
| (E,E)-3,5-Tetradecadienyl acetate | (E,Z)-2,13-Octadecadienal |
| (E,Z)-3,5-Tetradecadienyl acetate | (Z,E)-2,13-Octadecadienyl acetate |
| (Z,E)-3,5-Tetradecadienyl acetate | (Z,Z)-2,13-Octadecadien-1-ol |
| (E,Z)-3,7-Tetradecadienyl acetate | (Z,Z)-2,13-Octadecadienyl acetate |
| (E,Z)-3,8-Tetradecadienyl acetate | (E,E)-3,13-Octadecadienyl acetate |
| (E,Z)-4,9-Tetradecadienyl acetate | (E,Z)-3,13-Octadecadienyl acetate |
| (E,Z)-4,9-Tetradecadienal | (E,Z)-3,13-Octadecadienal |
| (E,Z)-4,10-Tetradecadienyl acetate | (Z,E)-3,13-Octadecadienyl acetate |
| (E,E)-5,8-Tetradecadienal | (Z,Z)-3,13-Octadecadienyl acetate |
| (Z,Z)-5,8-Tetradecadien-1-ol | (Z,Z)-3,13-Octadecadienal |
| (Z,Z)-5,8-Tetradecadienyl acetate | (E,E)-5,9-Octadecadien-1-ol |
| (Z,Z)-5,8-Tetradecadienal | (E,E)-5,9-Octadecadienyl acetate |
| (E,E)-8,10-Tetradecadien-1-ol | (E,E)-9,12-Octadecadien-1-ol |
| (E,E)-8,10-Tetradecadienyl acetate | (Z,Z)-9,12-Octadecadienyl acetate |
| (E,E)-8,10-Tetradecadienal | (Z,Z)-9,12-Octadecadienal |
| (E,Z)-8,10-Tetradecadienyl acetate | (Z,Z)-11,13-Octadecadienal |
| (E,Z)-8,10-Tetradecadienal | (E,E)-11,14-Octadecadienal |
| (Z,E)-8,10-Tetradecadien-1-ol | (Z,Z)-13,15-Octadecadienal |
| (Z,E)-8,10-Tetradecadienyl acetate | (Z,Z,Z)-3,6,9-Octadecatrienyl acetate |
| (Z,Z)-8,10-Tetradecadienal | (E,E,E)-9,12,15-Octadecatrien-1-ol |
| (E,E)-9,11-Tetradecadienyl acetate | (Z,Z,Z)-9,12,15-Octadecatrienyl acetate |
| (E,Z)-9,11-Tetradecadienyl acetate | (Z,Z,Z)-9,12,15-Octadecatrienal |
| (3E,8Z,11Z)-tetradecatrien-1-yl acetate | (3E,8Z)-tetradecadien-1-yl acetate |

In embodiments, sex pheromones include the C₆-C₂₀ pheromones described in Table 2. In embodiments, the compositions of the present disclosure comprise a sex pheromone described in Table 2. In embodiments, the compositions of the present disclosure comprise a mixture of sex pheromone in Table 2.

TABLE 2
Sex Pheromones of the Present Disclosure

| Name | Structure |
|---|---|
| (Z)-3-hexen-1-ol | 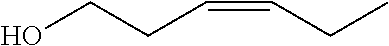 |
| (Z)-3-nonen-1-ol | 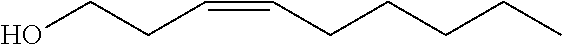 |
| (Z)-5-decen-1-ol | 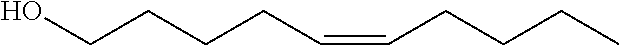 |
| (Z)-5-decenyl acetate | 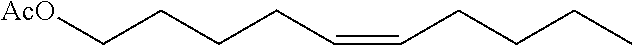 |
| (E)-5-decen-1-ol | 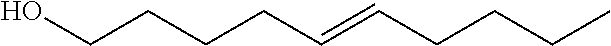 |
| (E)-5-decenyl acetate | 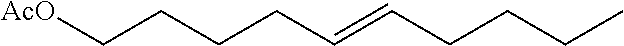 |
| (Z)-7-dodecen-1-ol | 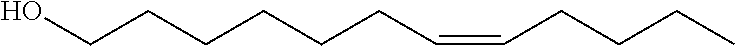 |
| (Z)-7-dodecenyl acetate | 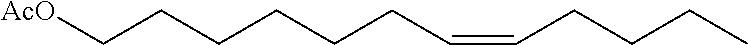 [SMILES: CCCC/C=C\CCCCCCOC(C)=O] |
| (E)-8-dodecen-1-ol | 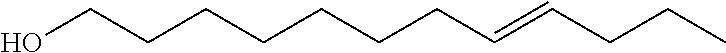 |
| (E)-8-dodecenyl acetate | 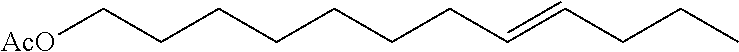 [SMILES: CCC/C=C/CCCCCCCOC(C)=O] |
| (Z)-8-dodecen-1-ol | 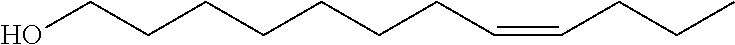 |
| (Z)-8-dodecenyl acetate | 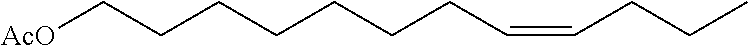 [SMILES: CCC/C=C\CCCCCCCOC(C)=O] |
| (Z)-9-dodecen-1-ol | 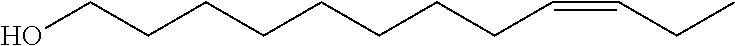 |
| (Z)-9-dodecenyl acetate | 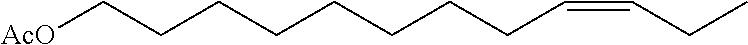 [SMILES: CC/C=C\CCCCCCCCOC(C)=O] |
| (Z)-9-Octadecenal | 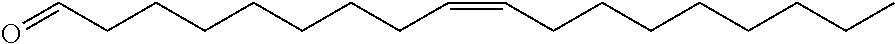 [SMILES: CCCCCCCC/C=C\CCCCCCCC=O] |
| (E,E)-8,10-dodecadien-1-ol | 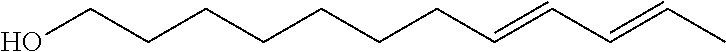 |
| (7E,9Z)-dodecadienyl acetate | 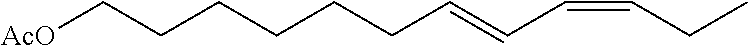 [SMILES: CC/C=C\C=C\CCCCCCOC(C)=O] |
| (Z)-9-tetradecen-1-ol | 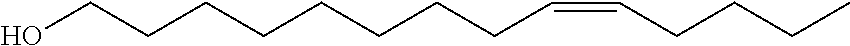 |
| (Z)-9-tetradecenyl acetate | 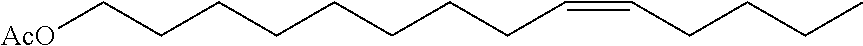 [SMILES: CCCC/C=C\CCCCCCCCOC(C)=O] |
| (Z)-11-tetradecen-1-ol | 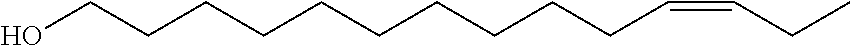 |
| (Z)-11-tetradecenyl acetate | 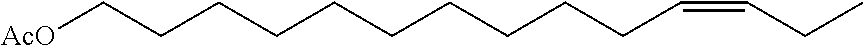 [SMILES: CC/C=C\CCCCCCCCCCOC(C)=O] |
| (E)-11-tetradecen-1-ol | 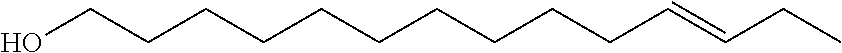 |
| (E)-11-tetradecenyl acetate | 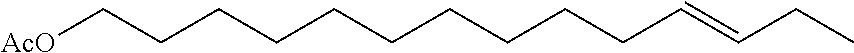 [SMILES: CC/C=C/CCCCCCCCCCOC(C)=O] |
| (Z)-7-hexadecen-1-ol | 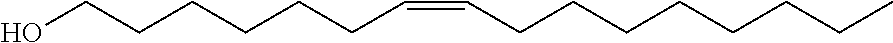 [SMILES: CCCCCCCC/C=C\CCCCCCO] |
| (Z)-7-hexadecenal | 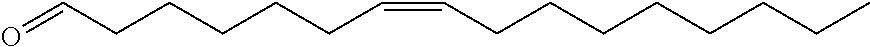 [SMILES: CCCCCCCC/C=C\CCCCCC=O] |
| (Z)-9-hexadecen-1-ol | 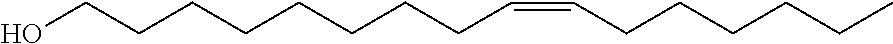 [SMILES: CCCCCC/C=C\CCCCCCCCO] |
| (Z)-9-hexadecenal | 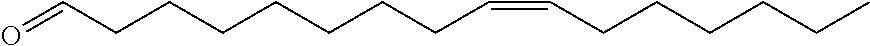 [SMILES: CCCCCC/C=C\CCCCCCCC=O] |
| (Z)-9-hexadecenyl acetate | 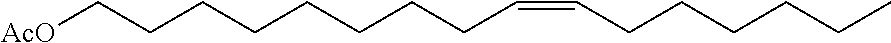 [SMILES: CCCCCC/C=C\CCCCCCCCOC(C)=O] |
| (Z)-11-hexadecen-1-ol | 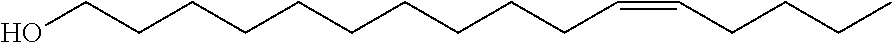 [SMILES: CCCC/C=C\CCCCCCCCCCO] |
| (Z)-11-hexadecenal | 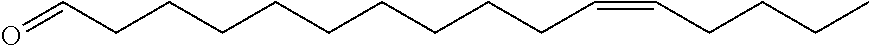 [SMILES: CCCC/C=C\CCCCCCCCCC=O] |
| (Z)-11-hexadecenyl acetate | 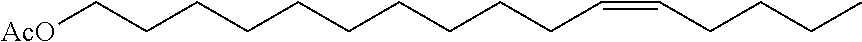 [SMILES: CCCC/C=C\CCCCCCCCCCOC(C)=O] |
| (Z,Z)-11,13-hexadecadienal | 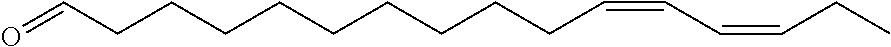 [SMILES: CC/C=C\C=C/CCCCCCCCCC=O] |
| (Z,Z)-11,13-hexadecadien-1-ol | 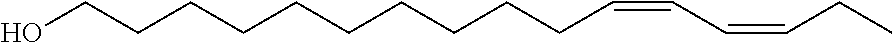 [SMILES: CC/C=C\C=C/CCCCCCCCCCO] |
| (11Z,13E)-hexadecadien-1-ol | 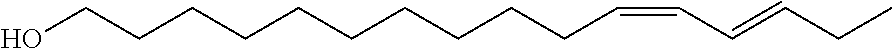 [SMILES: CC/C=C/C=C\CCCCCCCCCCO] |
| (9Z,11E)-hexadecadienal | 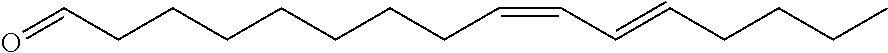 [SMILES: CCCC/C=C/C=C\CCCCCCCC=O] |
| (Z)-13-octadecen-1-ol | 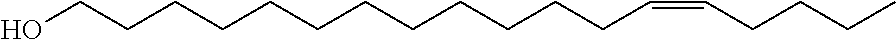 [SMILES: CCCC/C=C\CCCCCCCCCCCCO] |
| (Z)-13-octadecenal | 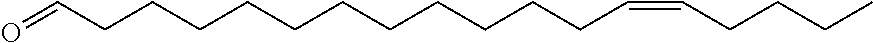 [SMILES: CCCC/C=C\CCCCCCCCCCCC=O] |
| (Z)-7-dodecenyl propionate | 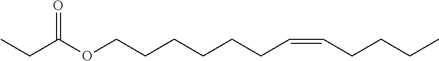 [SMILES: CCCC/C=C\CCCCCCOC(=O)CC] |
| (Z)-7-Dodecenyl butyrate | 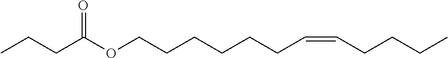 [SMILES: CCCC/C=C\CCCCCCOC(=O)CCC] |
| (Z,Z,Z,Z,Z)-3,6,9,12,15- tricosapentaene | 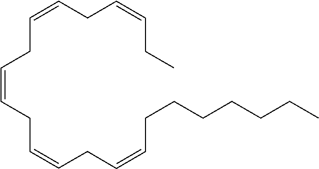 [SMILES: CC/C=C\C/C=C\C/C=C\C/C=C\C/C=C\CCCCCCC] |

In embodiments, the pheromone in a composition of the present disclosure comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), or mixtures thereof.

In embodiments, the pheromone in a composition of the present disclosure comprises (Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), or mixtures thereof.

In embodiments, the pheromone in a composition of the present disclosure comprises (Z)-9-Tetradecenyl Acetate (Z9-14Ac), (Z)-11-Hexadecenyl Acetate (Z11-16Ac), or mixtures thereof. In embodiments, the pheromone in a composition of the present disclosure comprises (Z)-7-dodecenyl acetate, (Z)-7-dodecenyl propionate (Z7-12Prop), (Z)-7-Dodecenyl bujtyrate (Z7-12Buty), or mixtures thereof.

### Pests

In some aspects, the present disclosure provides methods for controlling a population of one or more pests in an area (such as a field) where the agrochemical compositions of the present disclosure are applied. Persons skilled in the art can select the type and amount of an active ingredient, or mixture of active ingredients (such as a pheromone), that, when used in an agrochemical composition of the present disclosure, is effective for a particular pest (such Spodoptera frugiperda (fall armyworm)). The following are non-limiting examples of pests that may be controlled using the agrochemical compositions of the present disclosure.

In embodiments, the pests comprise one or more insects.

In embodiments, the pest comprises pests of the Phylum Nematoda. In embodiments, the pest comprises pests of the Phylum Arthropoda. In embodiments, the pest comprises pests of the Subphylum Chelicerata. In embodiments, the pests comprise pets of the Class Arachnida. In embodiments, the pests comprise pests of Subphylum Myriapoda. In embodiments, the pests comprise pests of the Class Symphyla. In embodiments, the pests comprise pests of the Subphylum Hexapoda. In embodiments, the pests comprise pests of the Class Insecta.

In embodiments, the pest comprises Coleoptera (beetles). A non-exhaustive list of these pests includes, but is not limited to, Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp., Cerotoma spp. (chrysomeids), Cerotoma trifurcate (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys fuscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus Mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (European chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle), and Zabrus tenebioides.

In embodiments, the pest comprises Dictyoptera (cockroaches). A non-exhaustive list of these pests includes, but is not limited to, Blattella germanica (German cockroach), Blatta orientalis (oriental cockroach), Parcoblatta pennylvanica, Periplaneta americana (American cockroach), Periplaneta australoasiae (Australian cockroach), Periplaneta brunnea (brown cockroach), Periplaneta fuliginosa (smokybrown cockroach), Pyncoselus suninamensis (Surinam cockroach), and Supella longipalpa (brownbanded cockroach).

In embodiments, the pest comprises Diptera (true flies). A non-exhaustive list of these pests includes, but is not limited to, Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cochlomyia spp. (screwworms), Contarinia spp. (gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (frit fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies), and Tipula spp. (crane flies).

In embodiments, the pest comprises Hemiptera (true bugs). A non-exhaustive list of these pests includes, but is not limited to, Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus Hesperus (western tarnished plant bug), Maconellicoccus hirsutus, Neurocolpus longirostris, Nezara viridula (southern green stink bug), Phytocoris spp. (plant bugs), Phytocoris cahfornicus, Phytocoris relativus, Piezodorus guildingi, Poecilocapsus lineatus (fourlined plant bug), Psallus vaccinicola, Pseudacysta perseae, Scaptocoris castanea, and Triatoma spp. (bloodsucking conenose bugs/kissing bugs).

In embodiments, the pest comprises Homoptera (aphids, scales, whiteflies, leafhoppers). A non-exhaustive list of these pests includes, but is not limited to, Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantia (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchase (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphin (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), and Zulia entreriana.

In embodiments, the pest comprises Hymenoptera (ants, wasps, and bees). A non-exhaustive list of these pests includes, but is not limited to, Acromyrrmex spp., Athalia rosae, Atta spp. (leafcutting ants), Camponotus spp. (carpenter ants), Diprion spp. (sawflies), Formica spp. (ants), Iridomyrmex humilis (Argentine ant), Monomorium ssp., Monomorium minimum (little black ant), Monomorium pharaonic (Pharaoh ant), Neodiprion spp. (sawflies), Pogonomyrmex spp. (harvester ants), Polistes spp. (paper wasps), Solenopsis spp. (fire ants), Tapoinoma sessile (odorous house ant), Tetranomorium spp. (pavement ants), Vespula spp. (yellow jackets), and Xylocopa spp. (carpenter bees).

In embodiments, the pest comprises Isoptera (termites). A non-exhaustive list of these pests includes, but is not limited to, Coptotermes spp., Coptotermes curvignathus, Coptotermes frenchii, Coptotermes formosanus (Formosan subterranean termite), Cornitermes spp. (nasute termites), Cryptotermes spp. (drywood termites), Heterotermes spp. (desert subterranean termites), Heterotermes aureus, Kalotermes spp. (drywood termites), Incistitermes spp. (drywood termites), Macrotermes spp. (fungus growing termites), Marginitermes spp. (drywood termites), Microcerotermes spp. (harvester termites), Microtermes obesi, Procornitermes spp., Reticulitermes spp. (subterranean termites), Reticulitermes banyulensis, Reticulitermes grassei, Reticulitermes flavipes (eastern subterranean termite), Reticulitermes hageni, Reticulitermes hesperus (western subterranean termite), Reticulitermes santonensis, Reticulitermes speratus, Reticulitermes tibialis, Reticulitermes virginicus, Schedorhinotermes spp., and Zootermopsis spp. (rotten-wood termites).

In embodiments, the pest comprises Lepidoptera (moths and butterflies). A non-exhaustive list of these pests includes, but is not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruit tree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leaf perforator), Caloptilia spp. (leaf miners), Capua reticulana, Carposina niponensis (peach fruit moth), Chilo spp., Chlumetia transversa (mango shoot borer), Choristoneura rosaceana (oblique banded leaf roller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwestern corn borer), Earias spp. (bollworms), Earias insulata (Egyptian bollworm), Earias vitelli (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobacco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicate (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparanal (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabs, Plodia interpunctella (Indian meal moth), Plutella xylostella (diamondback moth), Polychrosis viteana (grape berry moth), Prays endocarps, Prays oleae (olive moth), Pseudaletia spp. (noctuid moths), Pseudaletia unipunctata (armyworm), Pseudoplusia includens (soybean looper), Rachiplusia nu, Scirpophaga incertulas (yellow stemborer), Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera frugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer), and Zeuzerapyrina (leopard moth).

In embodiments, the pest comprises Mallophaga (chewing lice). A non-exhaustive list of these pests includes, but is not limited to, Bovicola ovis (sheep biting louse), Menacanthus stramineus (chicken body louse), and Menopon gallinea (common hen louse).

In embodiments, the pest comprises Orthoptera (grasshoppers, locusts, and crickets). A non-exhaustive list of these pests includes, but is not limited to, Anabrus simplex (Mormon cricket), Gryllotalpidae (mole crickets), Locusta migratoria, Melanoplus spp. (grasshoppers), Microcentrum retinerve (angular winged katydid), Pterophylla spp. (katydids), Chistocerca gregaria, Scudderia furcate (fork tailed bush katydid), and Valanga nigricorni.

In embodiments, the pest comprises Phthiraptera (sucking lice). A non-exhaustive list of these pests includes, but is not limited to, Haematopinus spp. (cattle and hog lice), Linognathus ovillus (sheep louse), Pediculus humanus capitis (human body louse), Pediculus humanus (human body lice), and Pthirus pubis (crab louse).

In embodiments, the pest comprises Siphonaptera (fleas). A non-exhaustive list of these pests includes, but is not limited to, Ctenocephalides canis (dog flea), Ctenocephalides felis (cat flea), and Pulex irritans (human flea).

In embodiments, the pest comprises Thysanoptera (thrips). A non-exhaustive list of these pests includes, but is not limited to, Frankliniellafusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis, and Thrips spp.

In embodiments, the pest comprises Thysanura (bristletails). A non-exhaustive list of these pests includes, but is not limited to, Lepisma spp. (silverfish) and Thermobia spp. (firebrats).

In embodiments, the pest comprises Acarina (mites and ticks). A non-exhaustive list of these pests includes, but is not limited to, Acarapsis woodi (tracheal mite of honeybees), Acarus spp. (food mites), Acarus siro (grain mite), Aceria mangiferae (mango bud mite), Aculops spp., Aculops lycopersici (tomato russet mite), Aculops pelekasi, Aculus pelekassi, Aculus schlechtendai (apple rust mite), Amblyomma Americanum (lone star tick), Boophilus spp. (ticks), Brevipalpus obovatus (privet mite), Brevipalpus phoenicis (red and black flat mite), Demodex spp. (mange mites), Dermacentor spp. (hard ticks), Dermacentor variabilis (American dog tick), Dermatophagoides pteronyssinus (house dust mite), Eotetranycus spp., Eotetranychus carpini (yellow spider mite), Epitimerus spp., Eriophyes spp., Ixodes spp. (ticks), Metatetranycus spp., Notoedres cati, Oligonychus spp., Oligonychus coffee, Oligonychus ilicus (southern red mite), Panonychus spp., Panonychus citri (citrus red mite), Panonychus ulmi (European red mite), Phyllocoptruta oleivora (citrus rust mite), Polyphagotarsonemun latus (broad mite), Rhipicephalus sanguineus (brown dog tick), Rhizoglyphus spp. (bulb mites), Sarcoptes scabiei (itch mite), Tegolophus perseaflorae, Tetranychus spp., Tetranychus urticae (two-spotted spider mite), and Varroa destructor (honey bee mite).

In embodiments, the pest comprises Nematoda (nematodes). A non-exhaustive list of these pests includes, but is not limited to, Aphelenchoides spp. (bud and leaf & pine wood nematodes), Belonolaimus spp. (sting nematodes), Criconemella spp. (ring nematodes), Dirofilaria immitis (dog heartworm), Ditylenchus spp. (stem and bulb nematodes), Heterodera spp. (cyst nematodes), Heterodera zeae (corn cyst nematode), Hirschmanniella spp. (root nematodes), Hoplolaimus spp. (lance nematodes), Meloidogyne spp. (root knot nematodes), Meloidogyne incognita (root knot nematode), Onchocerca volvulus (hook-tail worm), Pratylenchus spp. (lesion nematodes), Radopholus spp. (burrowing nematodes), and Rotylenchus reniformis (kidney-shaped nematode).

In embodiments, the pest comprises Symphyla (symphylans). A non-exhaustive list of these pests includes, but is not limited to, Scutigerella immaculata.

### Agrochemical Compositions and Methods of Making the Same

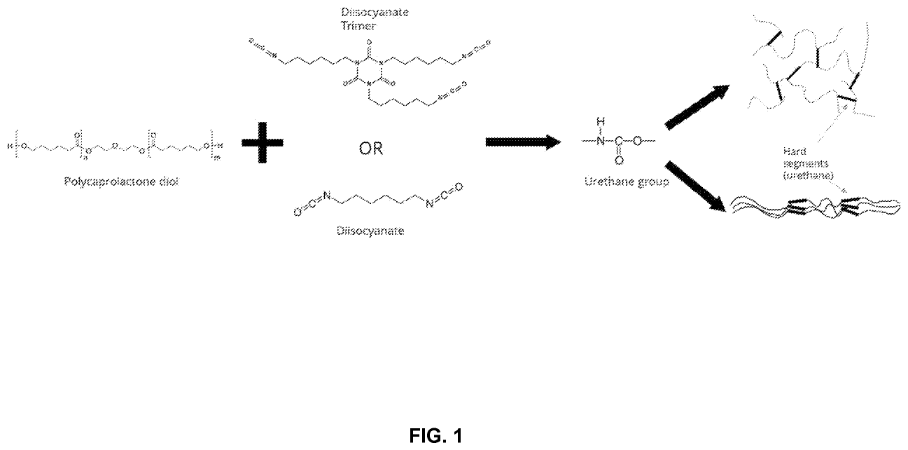

In one aspect, the present disclosure provides controlled-release agrochemical compositions and methods of manufacturing the same. The compositions of the present disclosure include a crosslinked matrix. In embodiments, the crosslinked matrix provides advantages, such as thermal stability, compared to compositions that do not include a crosslinked matrix. Crosslinked matrices include crosslinked polymers, such as those shown in FIG. 1.

In embodiments, the compositions of the present disclosure provide slow release of an active ingredient into the atmosphere. In embodiments, the compositions of the present disclosure are biodegradable.

In embodiments, a composition of the present disclosure comprises: (a) a crosslinked matrix; and (b) an active ingredient composition contained within the crosslinked matrix. In embodiments, the active ingredient composition is a semiochemical composition.

In embodiments, the compositions of the present disclosure have a melting point of about 50° C. to about 70° C. In embodiments, the composition has a melting point of about 50° C., about 55° C., about 56° C., about 58° C., about 60° C., about 62° C., about 64° C., about 66° C., about 68° C., or about 70° C., including all values and ranges there between.

In embodiments, the crosslinked matrix comprises polymers crosslinked by crosslinking monomers (e.g., isocyanates), such as those shown in FIG. 1.

In embodiments, a composition of the present disclosure comprises from about 10 wt % to about 98 wt % of a crosslinked matrix, e.g., about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In embodiments, the crosslinked matrix comprises one or more polymers. In embodiments, the polymer is a biodegradable polymer.

In embodiments, the biodegradable polymer is a hydroxy- or amine-containing biodegradable polymer. In embodiments, the hydroxy- or amine-containing biodegradable polymer is polycaprolactone (PCL), poly(butylene adipate-co-terephthalate) (PBAT), polybutylene succinate (PBS), polyhydroxyalkanoate (PHA), polylactic acid (PLA), or mixtures thereof. In embodiments, the biodegradable polymer is PCL. In embodiments, the biodegradable polymer is PLA.

In embodiments, the biodegradable polymer is a polyester. In embodiments, the polyester is PCL, PBAT, PBS, PHA, PLA, or a mixture thereof. In embodiments, the polyester is PCL. In embodiments, the polyester is PLA.

In embodiments, the crosslinked matrix comprises one or more non-biodegradable polymers. In embodiments, the non-biodegradable polymer is low density polyethylene (LDPE), ethylene-vinyl acetate (EVA), high density polyethylene (HDPE), polyvinyl acetate (PVA), or mixtures thereof.

In embodiments, a crosslinked matrix of the present disclosure comprises from about 10 wt % to about 98 wt % of a polymer, e.g., about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In embodiments, the crosslinked matrix comprises a crosslinking monomer that, upon reaction with a functional group (e.g., a primary amine, a secondary amine or a hydroxyl group) present in a polymer, provides crosslinks between polymers, resulting in a crosslinked polymer structure. In embodiments, the crosslinking monomer comprises a diisocyanate, a triisocyanate, or mixture thereof.

In embodiments, the crosslinking monomer is an aliphatic diisocyanate. In embodiments, the crosslinking monomer is hexamethylene diisocyanate, isophorone diisocyanate, 2,6-toluene diisocyanate, 2,4-toluene diisocyanate, 1,5-naphthylene diisocyanate, 4,4′-diphenylmethane diisocyanate, 2,4-toluenediisocyanate trimer, hexamethylene diisocyanate trimer, or a mixture. In embodiments, the crosslinking monomer is hexamethylene diisocyanate, isophorone diisocyanate, or a mixture thereof.

In embodiments, the crosslinked matrix comprises about 0.2 wt % to about 2.0 wt %, the crosslinking monomer, e.g., about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %, including all values and ranges there between.

In embodiments, the crosslinked matrix comprises a PCL polymer crosslinked by an isocyanate. In embodiments, the crosslinked matrix comprises a PCL polymer crosslinked by diisocyanate. In embodiments, crosslinked matrix comprises a PCL polymer crosslinked by a triisocyanate.

In embodiments, the crosslinked matrix comprises a PBS polymer crosslinked by an isocyanate. In embodiments, the crosslinked matrix comprises a PBS polymer crosslinked by diisocyanate. In embodiments, crosslinked matrix comprises a PBS polymer crosslinked by a triisocyanate.

In embodiments, the crosslinked matrix comprises a PHA polymer crosslinked by an isocyanate. In embodiments, the crosslinked matrix comprises a PHA polymer crosslinked by diisocyanate. In embodiments, the crosslinked matrix comprises a PHA polymer crosslinked by a triisocyanate.

In embodiments, the crosslinked matrix comprises a chain extender. Chain extenders couple polycondensate chains (i.e., crosslinked polymers) and thus, increase the resulting molecular weight of the polycondensates as shown in FIG. 1. In embodiments, the chain extenders increase the thermal stability of the resulting crosslinking matrix.

In embodiments, the chain extender is a short chain diol, primary amine, or diamine. In embodiments, the chain extender is a C₁-C₆ diol, C₁-C₆ primary amine, or C₁-C₆ diamine. In embodiments, the chain extender comprises urethane, urea, or mixtures thereof. In embodiments, the chain extender comprises polypropylene glycol, 1,4-butanediol, ethylene glycol, 1,6-hexanediol, diethylene glycol, diethyltoluene diamine, or mixtures thereof.

In embodiments, the compositions of the present disclosure comprise a filler. In embodiments, the filler is contained within the crosslinked matrix.

In embodiments, the filler is clay, a zeolite, talcum, shredded hay, cotton, cork, hemp, wood chips, wood dust, wood excelsior, microcrystalline cellulose, paper pulp, kaolin, calcined kaolin, chitosan, or mixture thereof. In embodiments, the clay is organoclay.

In embodiments, the filler comprises microcrystalline cellulose. In embodiments, the filler comprises kaolin. In embodiments, the filler comprises calcined kaolin.

In embodiments, the filler comprises a biomass from a fermentation.

In embodiments, the filler comprises an active filler (e.g., a filler capable of retaining the semiochemical).

In embodiments, a composition of the present disclosure comprises from about 1 wt % to about 98 wt % of a filler, e.g., about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In embodiments, the composition further comprises an additive, an antioxidant, a UV-blocking agent, an anticaking agent, or mixtures thereof.

In embodiments, the composition further comprises an additive. In embodiments, the additive is a dye, reflectant, inorganic salt, organic salt, or mixtures thereof.

In embodiments, a composition of the present disclosure comprises from about 0.01 wt % to about 5 wt % of an additive, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, including all values and ranges there between.

In embodiments, the composition further comprises an antioxidant. In embodiments, the antioxidant is butylated hydroxytoluene (BHT), tert-butylhydroquinone (TBHQ), Vitamin E, other antioxidants as known in the art, or mixtures thereof.

In embodiments, a composition of the present disclosure comprises from about 0.01 wt % to about 5 wt % of an antioxidant, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, including all values and ranges there between.

In embodiments, the composition further comprises a UV-blocking agent. In embodiments, the UV-blocking agent can include methyl cinnamate, iron oxides, carbon black, octabenzone, TiO2, avobenzone, other UV-blocking agents as known in the art, or mixtures thereof.

In embodiments, a composition of the present disclosure comprises from about 0.01 wt % to about 5 wt % of a UV-blocking agent, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, including all values and ranges there between.

In embodiments, the composition further comprises an anticaking agent. In embodiments, the anticaking agent is charcoal, amorphous silica, fumed silica, or mixtures thereof.

In embodiments, a composition of the present disclosure comprises from about 0 wt % to about 2 wt % of an anticaking agent, e.g., about 0 wt %, about 0.5 wt %, about 1 wt %, about 1.5 wt %, or about 2 wt %, including all values and ranges there between.

In embodiments, a composition of the present disclosure comprises an active ingredient composition (e.g., a semiochemical composition). In embodiments, a composition of the present disclosure comprises from about 1 wt % to about 70 wt % of an active ingredient composition comprising one or more active ingredients, e.g., about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt %, including all values and ranges therebetween.

In embodiments, the active ingredient composition comprises from about 10 wt % to about 98 wt % of one or more active ingredients. In embodiments, the active ingredient composition comprises from about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of one or more active ingredients. In embodiments, the active ingredient composition comprises about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt % of one or more active ingredients.

In embodiments, the composition comprises about 0.0001 wt % to about 20 wt % of a semiochemical composition, e.g., about 0.001 wt %, about 0.01 wt %, about 0.1 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14, wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, or about 40 wt %, including all values and ranges therebetween.

In embodiments, a composition of the present disclosure comprises from about 1 mg to about 5 g of an active ingredient composition. In embodiments, the composition comprises from about 1 mg to about 2 mg, about 1 mg to about 3 mg, about 1 mg to about 4 mg, about 1 mg to about 5 mg, about 2 mg to about 3 mg, about 2 mg to about 4 mg, about 2 mg to about 5 mg, about 3 mg to about 4 mg, about 3 mg to about 5 mg, or about 4 mg to about 5 mg of an active ingredient composition. In embodiments, the composition comprises about 1 mg, about 1.5 mg, about 2 mg, about 2.5 mg, about 3 mg, about 3.5 mg, about 4 mg, about 4.5 mg, or about 5 mg of an active ingredient composition.

In embodiments, a composition of the present disclosure further comprises a dye. In embodiments, the dye is Pigment Blue 15:3, CI Yellow 1, Solvent Green, Kenawax™, or mixtures thereof.

In embodiments, a composition of the present disclosure comprises an active ingredient composition and a filler, in which a weight ratio of the filler to active ingredient composition is 99:1 to 60:40, 20:80 to 80:20, or 1:1.

In embodiments, the active ingredient composition is a semiochemical composition comprising one or more semiochemicals. In embodiments, the semiochemical composition comprises pheromones. In embodiments, the semiochemical composition comprises one or more pheromones of Table 1 and Table 2. In embodiments, the semiochemical composition comprises Z7-12Ac, Z8-12Ac, Z9-12Ac, E7Z9-12Ac, Z11-14Ac, E5-10Ac, E8E10-10Ac, Z11-16Ac, or mixtures thereof. In embodiments, the semiochemical composition comprises Z9-16Ald, Z11-16Ald, Z13-18Ald, Z9-18Ald, or mixtures thereof. In embodiments, the semiochemical composition comprises Z9-14Ac, Z11-16Ac, or mixtures thereof. In embodiments, the semiochemical comprises Z9-14Ac and Z11-16Ac. In embodiments, the semiochemical comprises (Z)-7-dodecenyl acetate, Z7-12Prop, Z7-12Buty, or mixtures thereof.

In embodiments, the semiochemical composition comprises about 0.0001 wt % to about 20 wt % of (Z)-7-dodecenyl acetate, Z7-12Prop, Z7-12Buty, or mixtures thereof.

In embodiments, the semiochemical composition comprises about 75 wt % of Z9-16Ald, about 10 wt % of Z11-16Ald, about 8 wt % of Z13-18Ald, and about 7 wt % of Z9-18Ald.

In embodiments, the semiochemical composition comprises about 87 wt % of Z9-14Ac and about 13 wt % of Z11-16Ac.

In embodiments, the semiochemical composition comprises about 4 wt % Z7-12Ac, 75 wt % of Z9-14Ac, and about 2 wt % of Z11-16Ac.

In embodiments, the semiochemical composition comprises about 3 wt % to about 5 w % Z7-12Ac, 80 wt % to about 96 wt % of Z9-14Ac, and about 1 wt % to about 3 wt % of Z11-16Ac.

In embodiments, the semiochemical composition comprises about 2 w % Z7-12Ac, 87 wt % of Z9-14Ac, and about 11 wt % of Z11-16Ac.

In embodiments, the semiochemical composition comprises about 1 wt % to about 3 w % Z7-12Ac, 80 wt % to about 90 wt % of Z9-14Ac, and about 5 wt % to about 15 wt % of Z11-16Ac.

In embodiments, the semiochemical composition comprises Z9-16Ald, Z11-16Ald, and Z9-18Ald.

In embodiments, the semiochemical composition comprises Z9-16Ald, Z11-16Ald and Z13-18Ald.

In embodiments, the composition comprises PCL and calcined kaolin. In embodiments, the composition comprises PLA and calcined kaolin. In embodiments, the composition comprises PBS and calcined kaolin. In embodiments, the composition comprises PHA and calcined kaolin.

In embodiments, the composition comprises PCL and microcrystalline cellulose. In embodiments, the composition comprises PLA and microcrystalline cellulose. In embodiments, the composition comprises PBS and microcrystalline cellulose. In embodiments, the composition comprises PHA and microcrystalline cellulose.

In embodiments, a composition of the present disclosure comprises active ingredient droplets. In embodiments, the droplets are evenly distributed throughout the composition. In embodiments, a mean dimension of the droplet is from about 0.5 microns to about 5 microns. In embodiments, a mean dimension of the droplet is from about 0.5 microns to about 1 micron, about 0.5 micron to about 2 microns, about 0.5 microns to about 3 microns, about 0.5 microns to about 4 microns, about 0.5 microns to about 5 microns, about 1 micron to about 2 microns, about 1 micron to about 3 microns, about 1 micron to about 4 microns, about 1 micron to about 5 microns, about 2 microns to about 3 microns, about 2 microns about 4 microns, about 2 microns to about 5 microns, about 3 microns to about 4 microns, about 3 microns to about 5 microns, or about 4 microns to about 5 microns. In embodiments, the droplets have a mean dimension of about 0.5 microns, about 1 micron, about 1.5 micron, about 2 microns, about 2.5 microns, about 3 microns, about 3.5 microns, about 4 microns, about 4.5 microns, or about 5 microns.

In embodiments, a composition of the present disclosure is a granule. In embodiments, a composition of the present disclosure is a flake. In embodiments, a composition of the present disclosure is a dispenser. In embodiments, a composition of the present disclosure is a string.

In embodiments, a surface area of the composition (e.g., granule, flake, or dispenser) is from about 1 cm² to about 150 cm². In embodiments, a surface area of the composition is from about 1 cm² to about 10 cm², about 1 cm² to about 40 cm², about 1 cm² to about 80 cm², about 1 cm² to about 120 cm², about 1 cm² to about 140 cm², about 10 cm² to about 50 cm², about 10 cm² to about 90 cm², about 10 cm² to about 130 cm², about 10 cm² to about 150 cm², about 20 cm² to about 60 cm², about 20 cm² to about 100 cm², about 20 cm² to about 120 cm², about 20 cm² to about 150 cm², about 30 cm² to about 50 cm², about 30 cm² to about 80 cm², about 30 cm² to about 120 cm², about 40 cm² to about 60 cm², about 40 cm² to about 100 cm², about 40 cm² to about 150 cm², about 50 cm² to about 90 cm², about 50 cm² to about 120 cm², about 50 cm² to about 150 cm², about 60 cm² to about 90 cm², about 60 cm² to about 120 cm², about 60 cm² to about 150 cm², about 70 cm² to about 90 cm², about 70 cm² to about 130 cm², about 70 cm² to about 140 cm², about 80 cm² to about 100 cm², about 80 cm² to about 120 cm², about 90 cm² to about 130 cm², about 100 cm² to about 130 cm², or about 100 cm² to about 150 cm². In embodiments, a surface area of the composition is about 1 cm², about 10 cm², about 20 cm², about 30 cm², about 40 cm², about 50 cm², about 60 cm², about 70 cm², about 80 cm², about 90 cm², about 100 cm², about 110 cm², about 120 cm², about 130 cm², about 140 cm², or about 150 cm².

In embodiments, the composition is a granule. In embodiments, the granule is a cylinder, cube, sphere, irregular 3d object, or mixtures thereof.

In embodiments, a mean dimension of the granule is from about 0.1 mm to about 10 mm. In embodiments, a mean dimension of the granule is from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, a mean volume of the granule is from about 0.001 mm³ to about 1000 mm³. In embodiments, a mean volume of the granule is from about 0.001 mm³ to about 10 mm³, about 0.001 mm³ to about 100 mm³, about 0.001 mm³ to about 1000 mm³, about 0.01 mm³ to about 10 mm³, about 0.01 mm³ to about 100 mm³, about 0.01 mm³ to about 1000 mm³, about 1 mm³ to about 10 mm³, about 1 mm³ to about 100 mm³, about 1 mm³ to about 1000 mm³, about 10 mm³ to about 100 mm³, about 10 mm³ to about 1000 mm³, about 50 mm³ to about 100 mm³, about 50 mm³ to about 1000 mm³, or about 500 mm³ to about 1000 mm³. In embodiments, a mean volume of the granule is about 0.001 mm³, about 0.01 mm³, about 0.1 mm³, about 1 mm³, about 10 mm³, about 100 mm³, or about 1000 mm³.

In embodiments, the granule is a cylinder having a height from about 0.1 mm to about 10 mm. In embodiments, the granule is a cylinder having a height from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, the granule is a cylinder having a circumference from about 0.1 mm to about 10 mm. In embodiments, the granule is a cylinder having a circumference from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, the granule is a cylinder having a height and a circumference of about 0.1 mm, about 0.5 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In embodiments, the composition is a dispenser. In embodiments, the dispenser is in the shape of a cylindrical disc. In embodiments, the dispenser is in the shape of a rectangular prism.

In embodiments, a thickness of the dispenser is from about 0.1 mm to about 10 mm. In embodiments, a thickness of the dispenser is from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm. In embodiments, a thickness of the dispenser is about 0.1 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In embodiments, a height of the dispenser is from about 20 mm to about 80 mm. In embodiments, a height of the dispenser is from about 20 mm to about 30 mm, about 20 mm to about 40 mm, about 20 mm to about 50 mm, about 20 mm to about 60 mm, about 20 mm to about 70 mm, about 20 mm to about 80 mm, about 30 mm to about 40 mm, about 30 mm to about 50 mm, about 30 mm to about 60 mm, about 30 mm to about 70 mm, about 30 mm to about 80 mm, about 40 mm to about 50 mm, about 40 mm to about 60 mm, about 40 mm to about 70 mm, about 40 mm to about 80 mm, about 50 mm to about 60 mm, about 50 mm to about 70 mm, about 50 mm to about 80 mm, about 60 mm to about 70 mm, about 60 mm to about 80 mm, about 70 mm to about 80 mm. In embodiments, a height of the dispenser is about 20 mm, about 25 mm, about 30 mm, about 35 mm, about 40 mm, about 45 mm, about 50 mm, about 55 mm, about 60 mm, about 65 mm, about 70 mm, about 75 mm, or about 80 mm.

In embodiments, a length of the dispenser is from about 50 mm to about 150 mm. In embodiments, a length of the dispenser is from about 50 mm to about 60 mm, about 50 mm to about 70 mm, about 50 mm to about 80 mm, about 50 mm to about 80 mm, about 50 mm to about 90 mm, about 50 mm to about 100 mm, about 50 mm to about 110 mm, about 50 mm to about 120 mm, about 50 mm to about 130 mm, about 50 mm to about 140 mm, about 50 mm to about 150 mm, about 60 mm to about 70 mm, about 60 mm to about 80 mm, about 60 mm to about 90 mm, about 60 mm to about 100 mm, about 60 mm to about 110 mm, about 60 mm to about 120 mm, about 60 mm to about 130 mm, about 60 mm to about 140 mm, about 60 mm to about 150 mm, about 70 mm to about 80 mm, about 70 mm to about 90 mm, about 70 mm to about 100 mm, about 70 mm to about 110 mm, about 70 mm to about 120 mm, about 70 mm to about 130 mm, about 70 mm to about 140 mm, about 70 mm to about 150 mm, about 80 mm to about 90 mm, about 80 mm to about 100 mm, about 80 mm to about 110 mm, about 80 mm to about 120 mm, about 80 mm to about 130 mm, about 80 mm to about 140 mm, about 80 mm to about 150 mm, about 90 mm to about 100 mm, about 90 mm to about 110 mm, about 90 mm to about 120 mm, about 90 mm to about 130 mm, about 90 mm to about 140 mm, about 90 mm to about 150 mm, about 100 mm to about 110 mm, about 100 mm to about 120 mm, about 100 mm to about 130 mm, about 100 mm to about 140 mm, about 100 mm to about 150 mm, about 110 mm to about 120 mm, about 110 mm to about 130 mm, about 110 mm to about 140 mm, about 110 mm to about 150 mm, about 120 mm to about 130 mm, about 120 mm to about 140 mm, about 120 mm to about 150 mm, about 130 mm to about 140 mm, about 130 mm to about 150 mm, or about 140 mm to about 150 mm. In embodiments, a length of the dispenser is about 50 mm, about 60 mm, about 70 mm, about 80 mm, about 90 mm, about 100 mm, about 110 mm, about 120 mm, about 130 mm, about 140 mm, or about 150 mm.

In embodiments, the composition is a flake. In embodiments, a length of the flake is from about 1 mm to about 5 mm. In embodiments, a length of the flake is from about 1 mm to about 2 mm, about 1 mm to about 3 mm, about 1 mm to about 4 mm, about 1 mm to about 5 mm, about 2 mm to about 3 mm, about 2 mm to about 4 mm, about 2 mm to about 5 mm, about 3 mm to about 4 mm, about 3 mm to about 5 mm, or about 4 mm to about 5 mm. In embodiments, a length of a flake is of about 1 mm, about 2 mm, about 3 mm, about 4 mm, or about 5 mm.

In embodiments, a thickness of the flake is from about 0.5 mm to about 2 mm. In embodiments, a thickness of the flake is from about 0.5 mm to about 1 mm, about 0.5 mm to about 1.5 mm, about 0.5 mm to about 2 mm, about 1 mm to about 1.5 mm, about 1 mm to about 2 mm, or about 1.5 mm to about 2 mm. In embodiments, a thickness of the flakes is about 0.5 mm, about 1 mm, about 1.5 mm, or about 2 mm.

In embodiments, a height of a flake is from about 1 mm to about 5 mm. In embodiments, a height of the flake is from about 1 mm to about 2 mm, about 1 mm to about 3 mm, about 1 mm to about 4 mm, about 1 mm to about 5 mm, about 2 mm to about 3 mm, about 2 mm to about 4 mm, about 2 mm to about 5 mm, about 3 mm to about 4 mm, about 3 mm to about 5 mm, or about 4 mm to about 5 mm. In embodiments, a height of the flake is about 1 mm, about 2 mm, about 3 mm, about 4 mm, or about 5 mm.

In embodiments, the composition is a string. In embodiments, the composition is a string having a circumference from about 0.1 mm to about 10 mm. In embodiments, the granule is a cylinder having a circumference of the string is from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, a length of the string is from about 1 mm to about 10 mm. In embodiments, a length of the string is from about 1 mm to about 2 mm, about 1 mm to about 3 mm, about 1 mm to about 4 mm, about 1 mm to about 5 mm, about 2 mm to about 3 mm, about 2 mm to about 4 mm, about 2 mm to about 5 mm, about 3 mm to about 4 mm, about 3 mm to about 5 mm, about 4 mm to about 5 mm, about 1 mm to about 6 mm, about 3 mm to about 8 mm, about 5 mm to about 10. In embodiments, a length of the string is about 1 mm, about 2 mm, about 3 mm, about 4 mm, about 5 mm, about 6 mm, about 7 mm, about 8 mm, about 9 mm, or about 10 mm.

In embodiments, a composition of the present disclosure releases from about 0.15 gram/hectare (g/Ha) to about 4 g/Ha of the active ingredient per day after installation in a field. In embodiments, the composition releases from about 0.15 g/Ha, about 0.2 g/Ha, about 0.3 g/Ha, about 0.4 g/Ha, about 0.5 g/Ha, about 0.6 g/Ha, about 0.7 g/Ha, about 0.8 g/Ha, about 0.9 g/Ha, about 1 g/Ha, about 1.1 g/Ha, about 1.2 g/Ha, about 1.3 g/Ha, about 1.4 g/Ha, about 1.5 g/Ha, about 1.6 g/Ha, about 1.7 g/Ha, about 1.8 g/Ha, about 1.9 g/Ha, about 2 g/Ha, about 2.1 g/Ha, about 2.2 g/Ha, about 2.3 g/Ha, about 2.4 g/Ha, about 2.5 g/Ha, about 2.6 g/Ha, about 2.7 g/Ha, about 2.8 g/Ha, about 2.9 g/Ha, about 3 g/Ha, about 3.1 g/Ha, about 3.2 g/Ha, about 3.3 g/Ha, about 3.4 g/Ha, about 3.5 g/Ha, about 3.6 g/Ha, about 3.7 g/Ha, about 3.8 g/Ha, about 3.9 g/Ha, or about 4 g/Ha, including all values and ranges therebetween, of the active ingredient per day after installation in a field.

In embodiments, a composition of the present disclosure releases the active ingredient for at least about one month after installation in a field. In embodiments, the composition releases the active ingredient for at least about 1 month, at least about 2 months, at least about 3 months, at least about 4 months, at least about 5 months, at least about 6 months, at least about 7 months, at least about 8 months, at least about 9 months, at least about 10 months, about least about 11 months, at least about 1 year, or more after installation in a field.

In embodiments, a composition of the present disclosure provides zero order release of the active ingredient for at least about month after installation in a field. In embodiments, the dispenser provides zero order release of the active ingredient composition for at least about 1 month, at least about 2 months, at least about 3 months, at least about 4 months, at least about 5 months, at least about 6 months, at least about 7 months, at least about 8 months, at least about 9 months, at least about 10 months, about least about 11 months, at least about 1 year, or more after installation in a field.

In embodiments, a composition of the present disclosure degrades in about 6 months to about 4 years after installation in a field. In embodiments, the composition degrades in about 6 months to about 1 year, about 6 months to about 2 years, about 6 months to about 3 years, about 6 months to about 4 years, about 1 year to about 2 years, about 1 year to about 3 years, about 1 year to about 4 years, about 2 years to about 3 years, about 2 years to about 4 years, or about 3 years to about 4 years after installation in a field. In embodiments, the composition degrades in about 6 months, about 1 year, about 2 years, about 3 years, or about 4 years after installation in a field. In embodiments, about 70% to about 100% of the composition degrades after installation in a field after about 6 months to about 4 years. In embodiments, about 70% to about 80%, about 70% to about 90%, about 70% to about 100%, about 80% to about 90%, about 80% to about 100%, or about 90% to about 100% of the composition degrades after installation in a field after about 6 months to 4 years.

In embodiments, a composition of the present disclosure disrupts pest mating for at least about 30 days after installation to a field. In embodiments, the composition disrupts mating for at least about 50 days, at least about 55 days, at least about 60 days, at least about 65 days, at least about 70 days, at least about 75 days, at least about 80 days, at least about 85 days, at least about 90, at least about 95 days, or at least about 100 days after installation in a field.

In embodiments, a granule of the present disclosure disrupts pest mating for about 50 days after installation in a field. In embodiments, a dispenser of the present disclosure disrupts pest mating for about 90 days after installation in a field.

In embodiments, a composition of the present disclosure is contained in a sachet. In embodiments, a composition of the present disclosure comprises flakes contained in a sachet. In embodiment, a composition of the present disclosure comprises granules contained in a sachet.

In embodiments, a composition of the present disclosure comprises flakes, granules, or mixtures thereof. In embodiments, the flakes, granules, or mixtures thereof are joined together by a glue. In embodiments, the composition comprises flakes joined together by glue. In embodiments, the composition comprises granules joined together by glue.

In embodiments, the present disclosure provides a dispenser comprising a semiochemical composition comprising Z9-14Ac and Z11-16Ac. In embodiments, the dispenser comprises about 1.5 to about 3 g of the semiochemical composition. In embodiments, the dispenser comprises about 1.5 g, about 2 g, about 2.5 g, or about 3 g of the semiochemical composition.

In embodiments, a composition of the present disclosure comprises: (a) a crosslinked matrix comprising PCL; (b) a semiochemical composition comprising Z7-12Ac, Z9-14Ac, and Z11-16Ac contained within the crosslinked matrix; and (c) a filler comprising calcined kaolin contained within the crosslinked matrix. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, a composition of the present disclosure comprises: (a) a crosslinked matrix comprising PCL; (b) a semiochemical composition comprising Z7-12Ac, Z9-14Ac and Z11-16Ac contained within the crosslinked matrix, and (c) a filler comprising microcrystalline cellulose contained within the crosslinked matrix. In embodiments, a weight ratio of the PCL to semiochemical composition to filler is 1:1:1. In embodiments, the composition comprises a dispenser. In embodiments, the dispenser is a cylindrical disc comprising a thickness of about 1.5 mm, a length of about 55 mm, and a height of about 90 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the crosslinked matrix is prepared by a process comprising reacting:
a first mixture comprising a hydroxy- or amine-containing biodegradable polymer; and
a second mixture comprising a crosslinking monomer and an active ingredient.

In embodiments, the process further comprises:
mixing the first mixture and the second mixture to form a third mixture; and
extruding the third mixture to form the composition.

In embodiments, the process further comprises:
combining the first mixture with the second mixture, and
extruding the combined first mixture and second mixture to form the composition.

In embodiments, the hydroxy- or amine-containing is PCL, PBAT, PBS, PHA, PLA, or mixtures thereof. In embodiments, the biodegradable polymer is PCL. In embodiments, the biodegradable polymer is PLA.

In embodiments, the crosslinking monomer comprises diisocyanate, a triisocyanate, or mixture thereof.

In embodiments, the crosslinking monomer is an aliphatic diisocyanate. In embodiments, the crosslinking monomer is hexamethylene diisocyanate, isophorone diisocyanate, 2,6-toluene diisocyanate, 2,4-toluene diisocyanate, 1,5-naphthylene diisocyanate, 4,4′-diphenylmethane diisocyanate, 2,4-toluenediisocyanate trimer, hexamethylene diisocyanate trimer, or a mixture. In embodiments, the crosslinking monomer is hexamethylene diisocyanate, isophorone diisocyanate, or a mixture thereof.

In embodiments, the second mixture comprises a chain extender. In embodiments, the chain extender is a short chain diol, primary amine, or diamine. In embodiments, the chain extender is a C₁-C₆ diol, C₁-C₆ primary amine, or C₁-C₆ diamine. In embodiments, the chain extender comprises urethane, urea, or mixtures thereof. In embodiments, the chain extender comprises polypropylene glycol, 1,4-butanediol, ethylene glycol, 1,6-hexanediol, diethylene glycol, diethyltoluene diamine, or mixtures thereof.

In embodiments, the composition comprises from about 2 wt % to about 50 wt % of the second mixture, e.g., about 2 wt %, about 4 wt %, about 6 wt %, about 8 wt %, about 10 wt %, about 12 wt %, about 14 wt %, about 16 wt %, about 18 wt %, about 20 wt %, about 22 wt %, about 24 wt %, about 26 wt %, about 28 wt %, about 30 wt %, about 32 wt %, about 34 wt %, about 36 wt %, about 38 wt %, about 40 wt %, about 42 wt %, about 44 wt %, about 46 wt %, about 48 wt %, or about 50 wt %, including all values and ranges therebetween.

In embodiments, the composition comprises from about 0.01 wt % to about 5 wt % of a chain extender, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, including all values and ranges there between.

In embodiments, the composition comprises a catalyst (i.e., to facilitate crosslinking in the matrix). In embodiments, the catalyst comprises triethylene diamine (TEDA), dimethylpiperazine (DMP), dimethylethanolamine (DMEA), and diazabicyclooctane (DABCO), dibutyltin dilaurate (DBTL), vitamin E, or a mixture thereof.

In embodiments, the composition comprises from about 0.01 wt % to about 1 wt % of a catalyst, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, including all values and ranges there between.

In embodiments, the second mixture comprises an antioxidant. In embodiments, the antioxidant is butylated hydroxytoluene (BHT), tert-butylhydroquinone (TBHQ), or mixtures thereof.

In embodiments, the agrochemical composition comprises about 2 wt % to about 50 wt % the second mixture, e.g., about 5 wt %, about 10 wt %, about 15 wt %, about 20 wt %, about 25 wt %, about 30 wt %, about 35 wt %, about 40 wt %, about 45 wt %, or about 50 wt %, including all values and ranges therebetween.

In embodiments, the composition comprises from about 0.01 wt % to about 5 wt % of an antioxidant, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, including all values and ranges there between.

In embodiments, the second mixture comprises a UV-blocking agent. In embodiments, the UV-blocking agent is methyl cinnamate, iron oxides, carbon black, octabenzone, or mixtures thereof.

In embodiments, the composition comprises from about 0.01 wt % to about 5 wt % of a UV-blocking agent, e.g., about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, including all values and ranges there between.

In embodiments, the extruding step comprises twin-screw extrusion.

In embodiments, extruding step comprises extruding the mixtures through a sheet dyeing machine to produce the controlled-release composition.

In embodiments, the process comprises forming a controlled-release granule, flake, dispenser, or mixtures thereof.

In embodiments, the process further comprises: cooling the controlled-release composition. In embodiments, the processes comprise cooling the controlled-release composition using a water bath and/or an air-cooling conveyor belt.

In embodiments, the process further comprises: cutting the controlled-release composition to target dimensions (e.g., to form a granule, flake, and/or dispenser).

In embodiments, the process comprises extruding a string (e.g., cylindrical structure) of the composition and cutting the string to form granules.

In embodiments, the process comprises extruding a strip (e.g., flattened structure) of the composition and cutting the strip to form dispensers and/or flakes.

### Methods of Use

In one aspect, the present disclosure provides methods of controlling pest populations in a field comprising one or more pests. In embodiments, controlling pest populations in a field reduces and/or prevents plant damage in the field.

In embodiments, the methods of controlling pest populations comprise attracting or repelling pests from a particular field (e.g., target area such as a vulnerable crop). In embodiments, the methods of controlling pest populations comprise pest trapping, pest monitoring, pest killing, and/or pest mating disruption.

In embodiments, methods of the present disclosure relate to controlling pest populations in a field, the methods comprising applying an effective amount of an agrochemical composition described herein to the field.

In embodiments, methods of the present disclosure relate to preventing and/or reducing plant damage in a field comprising one or more pests, the methods comprising applying an effective amount of an agrochemical composition described herein to the field.

In embodiments, the field comprises plants grown in a variety of situations to include plants grown in field crops, large scale row crop fields, rangelands, forests, golf courses, and nurseries. In embodiments, the field comprises vegetable crops, fruit trees, nut trees, or mixtures thereof.

In embodiments, field crops include alfalfa, barley, Bermuda grass, buckwheat, cotton, clover, corn, oat, millet, peanut, rice paddy, ryegrass, sorghum, sugarbeet, sudangrass, soybean, sugarcane, timothy, tobacco, wheat, or mixtures thereof. In embodiments, the field crops include apple, grape, orange, papaya, peach, strawberry, or mixtures thereof. In embodiments, the field crops include weeds known to serve as common hosts to pests such as bentgrass, Agrostis sp.; crabgrass, Digitaria spp.; Johnson grass, Sorghum halepense; morning glory, Ipomoea spp.; nutsedge, Cyperus spp.; pigweed, Amaranthus spp.; sandspur, Cenchriis tribuloides, or mixtures thereof.

In embodiments, the field is a corn field, and the pest comprises fall armyworm (FAW). In embodiments, the field is a rice paddy field, and the pest comprises yellow rice stemborer.

In embodiments, the methods of controlling pest populations comprise trapping one or more pests in a field, the methods comprising applying an effective amount of an agrochemical composition described herein to the field. In embodiments, the methods comprise adding the agrochemical composition to a trap prior to application to the field. Such traps are well known to one skilled in the art and are commonly used in many states and countries in pest eradication programs. In embodiments, the trap includes one or more septa, containers, or storage receptacles for holding the composition. Thus, in embodiments, the present disclosure provides a trap loaded with at least one agrochemical composition of the present disclosure.

In embodiments, the methods of controlling pest populations comprise disrupting pest mating by modulating the behavior of the pests. Mating disruption is a pest management technique designed to control pests by introducing artificial stimuli (e.g., a composition comprising a sex pheromone as disclosed herein) that confuses the pests and disrupts mating localization and/or courtship, thereby preventing mating and blocking the reproductive cycle.

In embodiments, the methods of the present disclosure comprise controlling pest populations in a field, the methods comprising applying an effective amount of an agrochemical composition comprising one or more pheromones described herein to the field. In many pest species (e.g., insects), females emit an airborne trail (“pheromone plume”) of a specific chemical blend constituting that species' sex pheromone. Males of that species use the information contained in the pheromone plume to locate the emitting female. Mating disruption exploits the males' natural response to follow the plume by introducing a pheromone into the males' habitat, which is designed to mimic the sex pheromone produced by the female. Thus, in embodiments, the methods of the present disclosure comprise applying an agrochemical composition comprising one or more pheromones described herein to the field, in which the one or more pheromones is not produced by a female pest.

In embodiments, the methods of the present disclosure further comprise monitoring a population of one or more pests in a field. In embodiments, the methods of monitoring the pest populations comprise counting the number of pests trapped in the field daily, weekly, bi-weekly, monthly, one every three months, or once a year. In embodiments, monitoring the pest population can aid in determining a particular type and/or dose of a composition to apply to the field. For example, a discovery of a high insect population can necessitate the use of methods for removal of the insect. Early warning of an infestation in a new habitat can allow action to be taken before the population becomes unmanageable. Conversely, a discovery of a low pest population can lead to a decision that it is sufficient to continue monitoring the population. Pest populations can be monitored regularly so that the pests are only controlled when they reach a certain threshold.

In embodiments, the methods further comprise controlling pest populations in a field by killing one or more pests in the field. In embodiments, the methods comprise incorporating a toxic substance into a trap comprising an agrochemical composition described herein to kill the pests after trapping. In embodiments, the methods comprising incorporating a fungus or virus into the trap comprising an agrochemical composition described herein to kill the pests after trapping. In embodiments, the methods including killing one or more pests via drowning and/or electrocution.

In embodiments, the methods comprise suppressing pest mating after applying an agrochemical composition of the present disclosure to the field. In embodiments, the methods comprise suppressing pest mating by at least about 30%, at least about 40%, at least about 50%, at least about 60%, at least about 70%, at least about 80%, at least about 90%, or at least about 100% after applying the agrochemical composition to the field. In embodiments, the methods include suppressing mating relative to an untreated field.

In embodiments, the methods of the present disclosure comprise reducing a pest population by at least about 50% after applying an agrochemical composition of the present disclosure to the field. In embodiments, the methods comprise reducing the pest population by at least about 50%, at least about 60%, at least about 70%, at least about 80%, at least about 90%, or at least about 100% after applying the agrochemical composition to the field. In embodiments, the methods include reducing a pest population relative to an untreated field.

In embodiments, the methods of the present disclosure comprise controlling pest population for at least about 60 days after applying an agrochemical composition of the present disclosure to a field. In embodiments, the methods comprising controlling pest population for at least about 60 days, at least about 70 days, at least about 80 days, at least about 90 days, at least about 100 days, at least about 120 days, at least about 130 days, at least about 140 days, at least about 150 days, at least about 160 days, at least about 170 days, at least about 180 days, at least about 190 days, or at least about 200 days after the agrochemical composition to the field.

In embodiments, the methods of the present disclosure comprise controlling a pest population, the methods comprising applying an agrochemical composition comprising one or more pheromones, in which the composition emits one or more pheromones for a period of time equivalent to at least one breeding season. In embodiments, the agrochemical composition emits one or more pheromones for at least about 1 week, 2 weeks, 3 weeks, 4 weeks, 5 weeks, 6 weeks, or more after application to a field.

In embodiments, the methods comprise applying the composition to a field at a rate from about 10 grams of active ingredient per hectare (g a.i./ha) to about 150 g a.i/ha. In embodiments, the methods comprise applying the composition to a field at a rate from about 10 g a.i./ha to about 70 g a.i./ha, about 30 g a.i./ha or about 60 g a.i./ha, about 50 g a.i./ha to about 70 g a.i./ha, about 50 g a.i./ha to about 90 g a.i./ha, about 50 g a.i./ha to about 110 g a.i./ha, about 50 g a.i./ha to about 130 g a.i./ha, about 50 g a.i./ha to about 150 g a.i./ha, about 60 g a.i./ha to about 80 g a.i./ha, about 60 g a.i./ha to about 100 g a.i./ha, about 60 g a.i./ha to about 120 g a.i./ha, about 60 g a.i./ha to about 140 g a.i./ha, about 70 g a.i./ha to about 90 g a.i./ha, about 70 g a.i./ha to about 110 g a.i./ha, about 70 g a.i./ha to about 130 g a.i./ha, about 70 g a.i./ha to about 150 g a.i./ha, about 80 g a.i./ha to about 100 g a.i./ha, about 80 g a.i./ha to about 120 g a.i./ha, about 80 g a.i./ha to about 140 g a.i./ha, about 90 g a.i./ha to about 110 g a.i./ha, about 90 g a.i./ha to about 130 g a.i./ha, about 90 g a.i./ha to about 150 g a.i./ha, about 100 g a.i./ha to about 120 g a.i./ha, about 100 g a.i./ha to about 140 g a.i./ha, about 110 g a.i./ha to about 140 g a.i./ha, about 120 g a.i./ha to about 150 g a.i./ha, or about 130 g a.i./ha to about 150 g a.i./ha. In embodiments, the methods comprise applying the composition to a field at a rate of about 10 g a.i./ha, 20 g a.i./ha, about 30 g a.i./ha, about 40 g a.i./ha, about 50 g a.i./ha, about 60 g a.i./ha, about 70 g a.i./ha, about 80 g a.i./ha, about 90 g a.i./ha, about 100 g a.i./ha, about 110 g a.i./ha, about 120 g a.i./ha, about 130 g a.i./ha, about 140 g a.i./ha, or about 150 g a.i./ha.

As will be apparent to one of skill in the art, the amount of an active ingredient or active ingredient composition used for a particular application can vary depending on several factors such as the type and level of infestation; the type of composition used; the concentration of the active ingredients; how the composition is provided, for example, the type of composition used (e.g., granules, flakes, and dispensers); the type of location to be treated; the length of time the method is to be used for; and environmental factors such as temperature, wind speed and direction, rainfall and humidity. Those of skill in the art will be able to determine an effective amount of active agent or active agent composition for use in a given application.

In embodiments, the present disclosure provides methods of controlling pest population in a field, the methods comprising applying an effective amount of a composition comprising (a) a crosslinked matrix comprising PCL; (b) a semiochemical composition comprising Z9-14Ac and Z11-16Ac contained within the crosslinked matrix; and (c) a filler comprising calcined kaolin contained within the crosslinked matrix to the field. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling pest population in a field, the methods comprising applying an effective amount of a composition comprising (a) a crosslinked matrix comprising PCL; (b) a semiochemical composition comprising Z9-14Ac, Z7-12Ac and Z11-16Ac contained within the crosslinked matrix, and (c) a filler comprising microcrystalline cellulose contained within the crosslinked matrix to the field. In embodiments, a weight ratio of the PCL to semiochemical composition to filler is 1:1:1. In embodiments, the composition comprises a dispenser. In embodiments, the dispenser can be multiple shapes including rectangular, circular, square, oblong, cylindrical and be in a relatively flat form, in a disc form, in a cube form, comprising a thickness of about 1.5 mm, a length of about 55 mm, and a height of about 90 mm. In embodiments, the thickness is about 0.5 mm to about 5 mm. In embodiments, the length and width are about 20 mm to about 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling pest population in a field, the methods comprising applying an effective amount of a composition comprising (a) a crosslinked matrix comprising PCL; (b) a semiochemical composition comprising Z7-12Ac, Z9-14Ac and Z11-16Ac contained within the crosslinked matrix; and (c) a filler comprising calcined kaolin contained within the crosslinked matrix to the field. In embodiments, the semiochemical composition comprises 4 wt % Z7-12Ac, 94 wt % Z9-14Ac, and 2 wt % Z11-16Ac. In embodiments, the semiochemical composition comprises 2 wt % Z7-12Ac, 87 wt % Z9-14Ac, and 11 wt % Z11-16Ac.

In embodiments, the present disclosure provides methods of controlling pest population in a field, the methods comprising applying an effective amount of a composition comprising (a) a crosslinked matrix comprising PCL; (b) a semiochemical composition comprising Z9-16Ald, Z11-16Ald, and Z9-18Ald contained within the crosslinked matrix; and (c) a filler comprising calcined kaolin contained within the crosslinked matrix to the field.

In embodiments, the present disclosure provides methods of controlling pest population in a field, the methods comprising applying an effective amount of a composition comprising (a) a crosslinked matrix comprising PCL; (b) a semiochemical composition comprising Z9-14Ac and Z11-16Ac contained within the crosslinked matrix, and (c) a filler comprising microcrystalline cellulose contained within the crosslinked matrix to the field. In embodiments, a weight ratio of the PCL to semiochemical composition to filler is 1:1:1. In embodiments, the composition comprises a dispenser. In embodiments, the dispenser is rectangular, circular, square, oblong, cylindrical or a relatively flat form, e.g., in the form of a disc or cube. In embodiments, the dispenser has a thickness of about 1.5 mm, a length of about 55 mm, and a height of about 90 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling pest population in a field, the methods comprising applying an effective amount of a composition comprising (a) a crosslinked matrix comprising PCL; (b) a semiochemical composition comprising Z9-14Ac, Z7-12Ac and Z11-16Ac contained within the crosslinked matrix, and (c) a filler comprising microcrystalline cellulose contained within the crosslinked matrix to the field. In embodiments, a weight ratio of the PCL to semiochemical composition to filler is 1:1:1. In embodiments, the composition comprises a dispenser. In embodiments, the dispenser can be multiple shapes including rectangular, circular, square, oblong, cylindrical and be in a relatively flat form, in a disc form, in a cube form, comprising a thickness of about 1.5 mm, a length of about 55 mm, and a height of about 90 mm. In embodiments, the dispenser has thickness of about 0.5 mm to about 5 mm. In embodiments, the dispenser has a length and width from about 20 mm to about 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling FAW in corn, the methods comprising applying an effective amount of a composition comprising (a) a crosslinked matrix comprising PCL; (b) a semiochemical composition comprising Z9-14Ac, Z7-12Ac and Z11-16Ac contained within the crosslinked matrix; and (c) a filler comprising calcined kaolin contained within the crosslinked matrix to a cornfield. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the cylinder has a circumference of about 1 mm to about 5 cm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling pest population in a field, the methods comprising applying an effective amount of a composition comprising (a) a crosslinked matrix comprising PCL; (b) a semiochemical composition comprising Z7-12Ac, Z9-14Ac and Z11-16Ac contained within the crosslinked matrix, and (c) a filler comprising microcrystalline cellulose contained within the crosslinked matrix to the field. In embodiments, the semiochemical composition comprises 4 wt % Z7-12Ac, 94 wt % Z9-14Ac, and 2 wt % Z11-16Ac. In embodiments, the semiochemical composition comprises 2 wt % Z7-12Ac, 87 wt % Z9-14Ac, and 11 wt % Z11-11Ac.

In embodiments, the present disclosure provides methods of controlling pest population in a field, the methods comprising applying an effective amount of a composition comprising (a) a crosslinked matrix comprising PCL; (b) a semiochemical composition comprising Z9-16Ald, Z11-16Ald, and Z9-18Ald contained within the crosslinked matrix, and (c) a filler comprising microcrystalline cellulose contained within the crosslinked matrix to the field.

In embodiments, the present disclosure provides methods of controlling FAW in corn, the methods comprising applying an affective amount of an agrochemical composition described herein to a cornfield. In embodiments, the method controls FAW for about 60 days following application of a composition of the present disclosure to the cornfield.

In embodiments, the present disclosure provides methods of controlling FAW in corn, the methods comprising applying an effective amount of a composition comprising (a) a crosslinked matrix comprising PCL; (b) a semiochemical composition comprising Z9-14Ac and Z11-16Ac contained within the crosslinked matrix; and (c) a filler comprising calcined kaolin contained within the crosslinked matrix to a cornfield. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling FAW in corn, the methods comprising applying an effective amount of a composition comprising (a) a crosslinked matrix comprising PCL; (b) a semiochemical composition comprising Z9-14Ac, Z7-12Ac and Z11-16Ac contained within the crosslinked matrix, and (c) a filler comprising microcrystalline cellulose contained within the crosslinked matrix to a cornfield. In embodiments, a weight ratio of the PCL to semiochemical composition to filler is 1:1:1. In embodiments, the composition comprises a dispenser. In embodiments, the dispenser is a can be multiple shapes including rectangular, circular, square, oblong, cylindrical and be in a relatively flat form, in a disc form, in a cube form, comprising a thickness of about 1.5 mm, a length of about 55 mm, and a height of about 90 mm. In embodiments, the thickness is about 0.5 mm to about 5 mm. In embodiments, the length and width are about 20 mm to about 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling FAW in corn, the methods comprising applying an effective amount of a composition comprising (a) a crosslinked matrix comprising PCL; (b) a semiochemical composition comprising Z7-12Ac, Z9-14Ac and Z11-16Ac contained within the crosslinked matrix; and (c) a filler comprising calcined kaolin contained within the crosslinked matrix to a cornfield. In embodiments, the semiochemical composition comprises 4 wt % Z7-12Ac, 94 wt % Z9-14Ac, and 2 wt % Z11-16Ac. In embodiments, the semiochemical composition comprises 2 wt % Z7-12Ac, 87 wt % Z9-14Ac, and 11 wt % Z11-16Ac.

In embodiments, the present disclosure provides methods of controlling FAW in corn, the methods comprising applying an effective amount of a composition comprising (a) a crosslinked matrix comprising PCL; (b) a semiochemical composition comprising Z9-16Ald, Z11-16Ald, and Z9-18Ald contained within the crosslinked matrix; and (c) a filler comprising calcined kaolin contained within the crosslinked matrix to a cornfield.

In embodiments, the present disclosure provides methods of controlling FAW in corn, the methods comprising applying an effective amount of a composition comprising (a) a crosslinked matrix comprising PCL; (b) a semiochemical composition comprising Z9-14Ac and Z11-16Ac contained within the crosslinked matrix, and (c) a filler comprising microcrystalline cellulose contained within the crosslinked matrix to a cornfield. In embodiments, a weight ratio of the PCL to semiochemical composition to filler is 1:1:1. In embodiments, the composition comprises a dispenser. In embodiments, the dispenser is rectangular, circular, square, oblong, cylindrical or a relatively flat form, e.g., in the form of a disc or a cube. In embodiments, the dispenser has a thickness of about 1.5 mm, a length of about 55 mm, and a height of about 90 mm. In embodiments, the dispenser has a thickness from about 0.5 mm to about 5 mm, a length from about 20 mm to about 100 mm, and a width of about 20 mm to about 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z9-14Ac, Z7-12Ac and Z11-16Ac contained within the crosslinked matrix, and (c) a filler comprising microcrystalline cellulose contained within the crosslinked matrix to a rice paddy field. In embodiments, a weight ratio of the PCL to semiochemical composition to filler is 1:1:1. In embodiments, the composition comprises a dispenser. In embodiments, the dispenser can be multiple shapes including rectangular, circular, square, oblong, cylindrical and be in a relatively flat form, in a disc form, in a cube form, comprising a thickness of about 1.5 mm, a length of about 55 mm, and a height of about 90 mm. In embodiments, the thickness is about 0.5 mm to about 5 mm. The length and width can range from 20 mm to 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling FAW in corn, the methods comprising applying an effective amount of a composition comprising (a) a crosslinked matrix comprising PCL; (b) a semiochemical composition comprising Z7-12Ac, Z9-14Ac and Z11-16Ac contained within the crosslinked matrix, and (c) a filler comprising microcrystalline cellulose contained within the crosslinked matrix to a cornfield. In embodiments, the semiochemical composition comprises 4 wt % Z7-12Ac, 94 wt % Z9-14Ac, and 2 wt % Z11-16Ac. In embodiments, the semiochemical composition comprises 2 wt % Z7-12Ac, 87 wt % Z9-14Ac, and 11 wt % Z11-16Ac.

In embodiments, the present disclosure provides methods of controlling FAW in corn, the methods comprising applying an effective amount of a composition comprising (a) a crosslinked matrix comprising PCL; (b) a semiochemical composition comprising Z9-16Ald, Z11-16Ald, and Z9-18Ald contained within the crosslinked matrix, and (c) a filler comprising microcrystalline cellulose contained within the crosslinked matrix to a cornfield.

In embodiments, the present disclosure provides methods of controlling yellow rice stemborer in rice, the methods comprise applying an affective amount of an agrochemical composition described herein to a rice paddy field. In embodiments, the methods control yellow rice stemborer for about 60 days following application to the rice paddy field.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z9-14Ac and Z11-16Ac contained within the crosslinked matrix; and (c) a filler comprising calcined kaolin contained within the crosslinked matrix to a rice paddy field. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z9-14Ac, Z7-12Ac and Z11-16Ac contained within the crosslinked matrix, and (c) a filler comprising microcrystalline cellulose contained within the crosslinked matrix to a rice paddy field. In embodiments, a weight ratio of the PCL to semiochemical composition to filler is 1:1:1. In embodiments, the composition comprises a dispenser. In embodiments, the dispenser is a can be multiple shapes including rectangular, circular, square, oblong, cylindrical and be in a relatively flat form, in a disc form, in a cube form, comprising a thickness of about 1.5 mm, a length of about 55 mm, and a height of about 90 mm. In embodiments, the thickness is about 0.5 mm to about 5 mm. In embodiments, the length and width are about 20 mm to about 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z7-12Ac, Z9-14Ac and Z11-16Ac contained within the crosslinked matrix; and (c) a filler comprising calcined kaolin contained within the crosslinked matrix to a rice paddy field. In embodiments, the semiochemical composition comprises 4 wt % Z7-12Ac, 94 wt % Z9-14Ac, and 2 wt % Z11-16Ac. In embodiments, the semiochemical composition comprises 2 wt % Z7-12Ac, 87 wt % Z9-14Ac, and 11 wt % Z11-16Ac.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z9-16Ald, Z11-16Ald, and Z9-18Ald, contained within the crosslinked matrix; and (c) a filler comprising calcined kaolin contained within the crosslinked matrix to a rice paddy field. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, a weight ratio of Z9-16Ald: Z11-16Ald: Z9-18Ald, is about 16.7:66.6:16.7. In embodiments, the weight ratio of Z9-16Ald: Z11-16Ald: Z13-18Ald is 5:50:6.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z9-14Ac and Z11-16Ac contained within the crosslinked matrix, and (c) a filler comprising microcrystalline cellulose contained within the crosslinked matrix to a rice paddy field. In embodiments, a weight ratio of the PCL to semiochemical composition to filler is 1:1:1. In embodiments, the composition comprises a dispenser. In embodiments, the dispenser is rectangular, circular, square, oblong, cylindrical or in a relatively flat form, in a disc form, in a cube form, comprising a thickness of about 1.5 mm, a length of about 55 mm, and a height of about 90 mm. In embodiments, the dispenser has a thickness from about 0.5 mm to about 5 mm, a length from about 20 mm to about 100 mm, and a height of about 20 mm to about 100 mm. In embodiments, the semiochemical composition further comprises an antioxidant. In embodiments, the antioxidant is TBHQ, BHT, or mixtures thereof. In embodiments, the semiochemical composition comprises about 0.5 wt % TBHQ, 0.5 wt % BHT, or mixtures thereof. In embodiments, the composition further comprises an anticaking agent.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z7-12Ac, Z9-14Ac and Z11-16Ac contained within the crosslinked matrix, and (c) a filler comprising microcrystalline cellulose contained within the crosslinked matrix to a rice paddy field. In embodiments, the semiochemical composition comprises 4 wt % Z7-12Ac, 94 wt % Z9-14Ac, and 2 wt % Z11-16Ac. In embodiments, the semiochemical composition comprises 2 wt % Z7-12Ac, 87 wt % Z9-14Ac, and 11 wt % Z11-16Ac.

In embodiments, the present disclosure provides methods of controlling yellow rice stemborer in rice, the methods comprising applying an effective amount of a composition comprising (a) a crosslinked matrix comprising PCL; (b) a semiochemical composition comprising Z9-16Ald, Z11-16Ald, and Z9-18Ald, contained within the crosslinked matrix, and (c) a filler comprising microcrystalline cellulose contained within the crosslinked matrix to a rice paddy field.

### NUMBERED EMBODIMENTS

1. A controlled-release agrochemical composition comprising:
   a crosslinked matrix; and
   a semiochemical composition contained within the crosslinked matrix.
2. The composition of embodiment 1, wherein the melting point of the composition is greater than 50° C.
3. The composition of any one of embodiments 1-2, wherein the composition is prepared by a process comprising reacting:
   a first mixture comprising a hydroxy- or amine-containing biodegradable polymer and
   a second mixture comprising crosslinking monomer and the semiochemical composition.
4. The composition of embodiment 3, further comprising mixing the first mixture and the second mixture to form a third mixture and then, extruding the third mixture to form the dispenser.
5. The composition of embodiment 3, further comprising combining the first mixture with the second mixture and then, extruding the combined first mixture and second mixture to form the dispenser.
6. The composition of any one of embodiments 3-5, wherein the second mixture further comprises a chain extender.
7. The composition of embodiment 6, wherein the chain extender comprises polypropylene glycol, 1,4-butanediol, ethylene glycol, 1,6-hexanediol, diethylene glycol, diethyltoluene diamine, or a mixture thereof.
8. The composition of any one of embodiments 3-7, wherein the second mixture further comprises a catalyst.
9. The composition of embodiment 8, wherein the catalyst comprises triethylene diamine (TEDA), dimethylpiperazine (DMP), dimethylethanolamine (DMEA), and diazabicyclooctane (DABCO), dibutyltin dilaurate (DBTL), or a mixture thereof.
10. The composition of any one of embodiments 3-9, wherein the second mixture further comprises an antioxidant.
11. The composition of any one of embodiments 1-10, wherein the crosslinked matrix comprises about 0.01% to about 5% by weight of an antioxidant.
12. The composition of any one of embodiments 3-11, wherein the second mixture further comprises a UV-blocking agent.
13. The composition of embodiment 12, wherein the UV-blocking agent comprises methyl cinnamate, iron oxides, carbon black, octabenzone, avobenzone or a mixture thereof.
14. The composition of embodiments 1-13 further comprising a dye such as solvent green 3 and Kenawax.
15. The composition of any one of embodiments 3-14, wherein the dispenser further comprises an anticaking agent.
16. The composition of embodiment 15, wherein the anticaking agent is charcoal, amorphous silica, fumed silica, or a mixture thereof.
17. The composition of embodiments 1-16, wherein the composition comprises about 0 wt % to about 2 wt % of an anticaking agent.
18. The composition of any one of embodiments 3-17, wherein the biodegradable polymer is a polyester.
19. The composition of embodiment 18, wherein the polyester is polycaprolactone (PCL), poly(butylene adipate-co-terephthalate) (PBAT), polybutylene succinate (PBS), polyhydroxyalkanoate (PHA), polylactic acid (PLA), or a mixture thereof.
20. The composition of embodiment 18, wherein the polyester is PCL.
21. The composition of any one of embodiments 3-19, wherein the crosslinking monomer comprises a diisocyanate, a triisocyanate, or a mixture thereof.
22. The composition of embodiment 21, wherein the crosslinking monomer is an aliphatic or aromatic crosslinking monomer.
23. The composition of embodiment 21, wherein the crosslinking monomer is hexamethylene diisocyanate, isophorone diisocyanate, 2,6-toluene diisocyanate, 2,4-toluene diisocyanate, 1,5-naphthylene diisocyanate, 4,4′-diphenylmethane diisocyanate, 2,4-toluenediisocyanate trimer, hexamethylene diisocyanate trimer, or a mixture.
24. The composition of embodiment 21, wherein the crosslinking monomer is hexamethylene diisocyanate, isophorone diisocyanate, or a mixture thereof.
25. The composition of any one of embodiments 3-24, wherein the crosslinked matrix comprises about 0.2% to about 5.0% by weight of the crosslinking monomer.
26. The composition of any one of embodiments 1-25, further comprising a filler contained within the crosslinked matrix.
27. The composition of embodiment 26, wherein the filler is selected from the group consisting of a clay (including organoclay), a zeolite, talcum, shredded hay, cotton, cork, hemp, wood chips, wood dust, wood excelsior, microcrystalline cellulose, paper pulp, kaolin, calcined kaolin, cyclodextrin, chitosan, or mixtures thereof.
28. The composition of embodiment 26, wherein the filler is a biomass from a fermentation.
29. The composition of any one of embodiments 26-28, wherein the filler is an active filler (i.e., a filler that retains the semiochemical).
30. The composition of any one of embodiments 26-29, wherein the composition comprises about 1 wt % to about 80 wt % of filler.
31. The composition of any one of embodiments 1-30, wherein the composition comprises 0.0001% to 40%, by weight, the semiochemical composition.
32. The composition of any one of embodiments 1-31, wherein the composition is a dispenser in the shape of a cylindrical disc or rectangular prism.
33. The composition of embodiment 32, wherein the surface area of the dispenser is from about 50 cm² to about 300 cm²
34. The composition of embodiment 32, wherein the surface area of the dispenser is from about 1 cm² to about 100 cm².
35. The composition of embodiment 32, wherein the thickness of the dispenser is from about 0.1 mm to about 10 mm.
36. The composition of embodiment 32, wherein the thickness of the dispenser is from about 0.1 mm to about 4 mm.
37. The composition of embodiment 32, wherein the thickness of the dispenser is from about 1 mm to about 10 mm.
38. The composition of any one of embodiments 1-37, wherein the semiochemical composition is selected from the group consisting of an allomone, a kairomone, a pheromone, or mixtures thereof.
39. The composition of any one of embodiments 1-38, wherein the semiochemical composition comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-9-Tetradecenyl acetate (Z9-14Ac), (Z)-11-Tetradecenyl acetate (Z11-14Ac), (Z)-11-Hexradecenyl acetate (Z11-16Ac) (E)-5-Decenyl acetate (E5-10Ac), (E,E)-8,10-Decadienyl acetate (E8E10-10Ac), (Z)-11-Hexadecenyl acetate (Z11-16Ac), or mixtures thereof.
40. The composition of any one of embodiments 1-38, wherein the semiochemical composition comprises (Z)-9-Hexadecenal (Z9-16Ald), (Z)-11-Hexadecenal (Z11-16Ald), (Z)-13-Octadecenal (Z13-18Ald), and (Z)-9-Octadecenal (Z9-18Ald).
41. The composition of any one of embodiments 1-38, wherein the semiochemical composition comprises (Z)-9-Tetradecenyl Acetate (Z9-14Ac) and (Z)-11-Hexadecenyl Acetate (Z11-16Ac).
42. The composition of embodiment 41, wherein the semiochemical composition comprises about 87 wt % of (Z)-9-Tetradecenyl Acetate (Z9-14Ac) and about 13 wt % of (Z)-11-Hexadecenyl Acetate (Z11-16Ac).
43. The composition of any one of embodiments 1-42, wherein the composition comprises about 1% to about 50% by weight of the semiochemical composition.
44. The composition of any one of embodiments 1-43, wherein the composition comprises about 1 mg to about 5 g of the semiochemical composition.
45. The composition of any one of embodiments 1-44, wherein the composition releases from 0.15 g/Ha to 4 g/Ha of the semiochemical per day after installation in a field.
46. The composition of any one of embodiments 1-45, wherein the composition releases the semiochemical for at least about a month after installation in a field.
47. A controlled-release agrochemical flake comprising
   a crosslinked matrix; and
   a semiochemical composition contained within the crosslinked matrix.
48. A controlled-release agrochemical granule comprising:
   a crosslinked matrix; and
   a semiochemical composition contained within the crosslinked matrix.
49. The granule of embodiment 48, wherein the shape of the granule is a cylinder, cube, sphere, irregular 3d object, or a mixture thereof.
50. The granule of any one of embodiments 48-49, wherein the mean dimension of the granule is from about 0.1 mm to about 10 mm.
51. The granule of any one of embodiments 48-50, wherein the mean volume of the granule is from about 0.001 mm³ to about 1000 mm³.
52. A controlled-release agrochemical dispenser comprising the flakes of embodiment 47 or the granules of any one of embodiments 48-51 contained in a sachet.
53. A controlled-release agrochemical dispenser comprising the flakes embodiment 47 or the granules of any one of embodiments 48-51 joined together by a glue.
54. A method of controlling a lepidopteran pest, the method comprising applying an effective amount of the controlled-release agrochemical dispenser of any one of embodiments 1-46, the flake of embodiment 47 or the granule of any one of embodiments 48-51 to a corn field.
55. The method of embodiment 54, wherein the application rate is from about 10 g a.i./ha to about 150 g a.i./ha.
56. The method of any one of embodiments 54-55, wherein the method controls FAW for about 60 days following application.
57. A method of controlling yellow rice stemborer in rice, the method comprising applying an effective amount of the controlled-release agrochemical dispenser of any one of embodiments 1-47, the flake of embodiment 48 or the granule of any one of embodiments 49-52 to a rice paddy field.
58. The method of embodiment 57, wherein the method controls yellow rice stemborer for about 60 days following application.
59. A process for making a controlled-release agrochemical dispenser, flake or granule, the method comprising reacting:
   a first mixture comprising a hydroxy- or amine-containing biodegradable polymer and
   a second mixture comprising crosslinking monomer and the semiochemical composition.
60. The process of embodiment 59, wherein the reaction is conducted by twin-screw extrusion.

### EXAMPLES

The present invention is further illustrated by reference to the following Examples. However, it is noted that that Examples, like the embodiments described above, are illustrative and are not to be construed as restricting the scope of the invention in any way.

### Example 1—Methods of Making Agrochemical Compositions and Associated Characterizations

The following example provides an exemplary method for preparing agrochemical compositions of the present disclosure comprising a crosslinked matrix, as well as the properties of the compositions. The physical crosslinking of the polymer results in a composition having higher thermal stability and melt strength.

FIG. 1 shows an exemplary reaction to form a crosslinked matrix described herein. As shown in FIG. 1, PCL reacts with a crosslinking monomer, isocyanate (e.g., diisocyanate or triisocyanate) to form a crosslinked matrix. The reaction can include an optional step of reacting the PCL and isocyanate with a chain extender (e.g., a urethane) to form the crosslinked matrix.

Thermal Stability of PCL-Polyurethane v. PCL and PBS Only Matrices

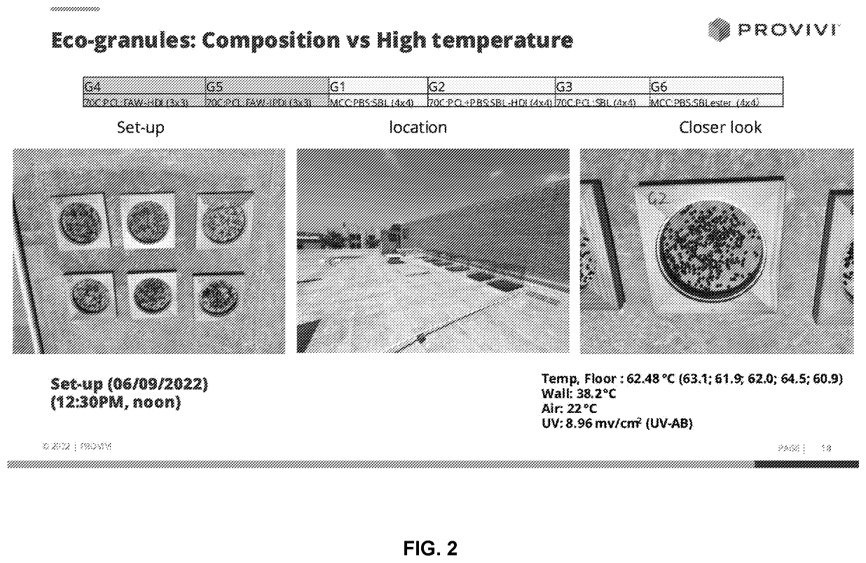

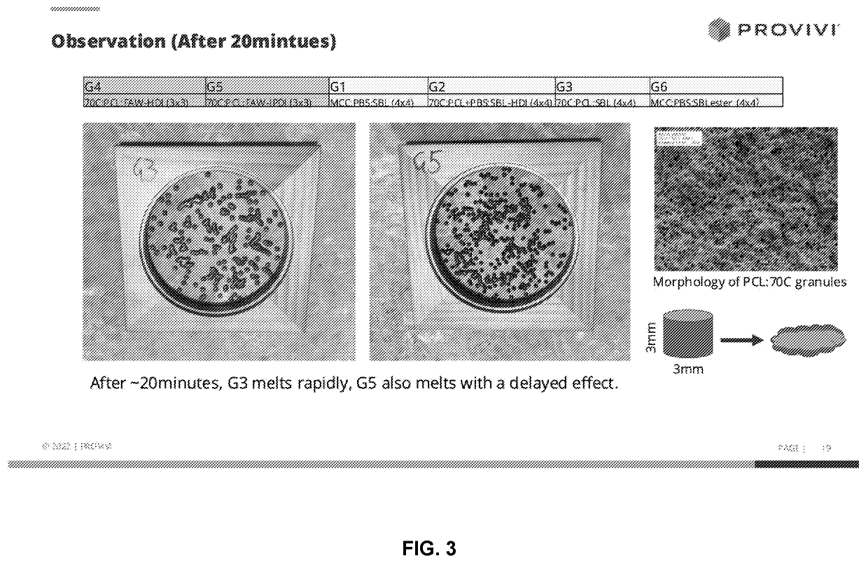

Thermal stability of granules including the PCL-polyurethane crosslinked matrices were then compared to granules including only PCL, PCL plus PBS, and PBS (FIGS. 2-4). FIGS. 2-4 show that granules including the PCL-polyurethane crosslinked matrices (labeled as G4 (crosslinker hexamethylene diisocyanate) and G5 (crosslinker isophorone diisocyanate)) have increased thermal stability as compared to granules comprising only PCL (labeled as G3), PCL plus PBS (labeled as G2), or PBS (labeled as G1 and G6). Each of the granules were placed in a location (FIG. 2, “location”) where the temperature on the floor was ˜60° C., the wall was ˜38° C., the air was 22° C., and the UV was 8.96 mv/cm². As demonstrated in FIG. 3, PCL only granules rapidly melted within 20 minutes (G3), whereas granules having PCL-polyurethane crosslinked matrices (G5) did not.

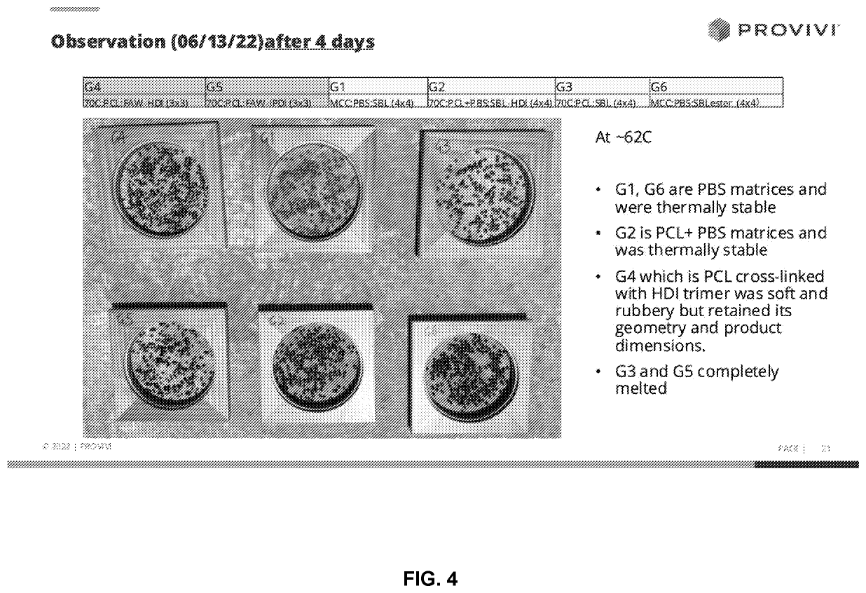

After 4 days at ˜60° C., the PBS and PBS+PCL granules were thermally stable and the PCL cross-linked matrices were rubbery but retained geometry (FIG. 4).

Thermal Stability of PCL-Polyurethane v. PCL Only Matrices

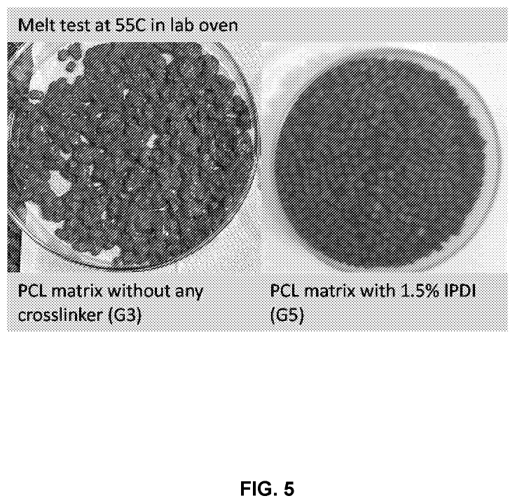

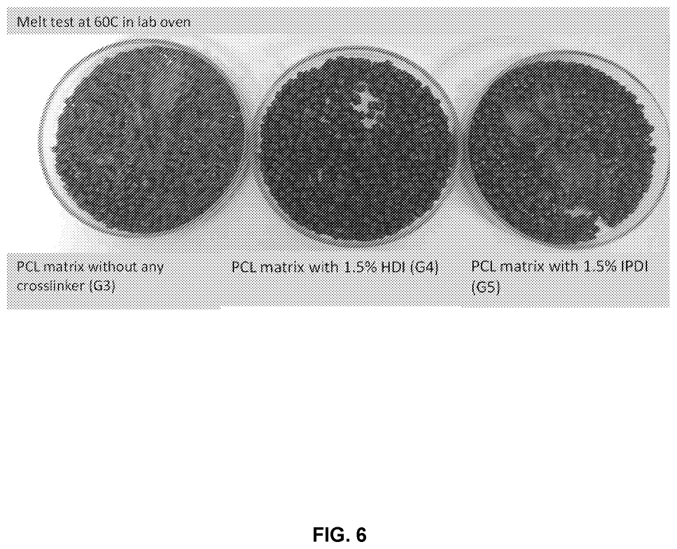

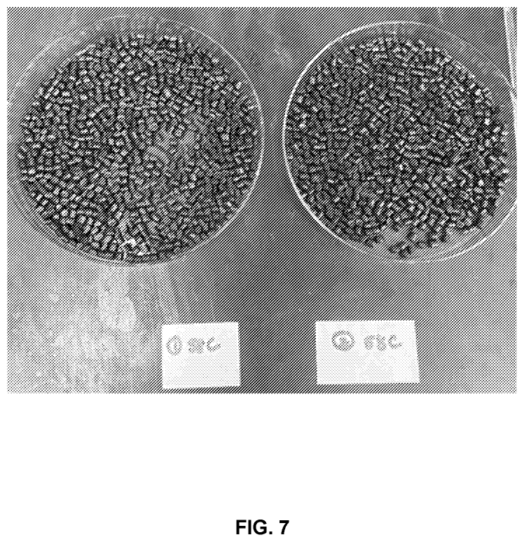

Thermal stability of granules including the PCL-polyurethane crosslinked matrices were then compared to granules including only PCL matrices (FIGS. 5-6). FIG. 5 shows that granules including the PCL-polyurethane crosslinked matrices with crosslinker as Isophorone diisocyanate (added at 1.5% w/w) and labelled as G5, do not melt at 55° C. and have increased thermal stability as compared to granules comprising only PCL (labeled as G3). FIG. 6 shows that the granules including the PCL-polyurethane matrices with Hexamethylene diisocyanate (added at 1.5% w/w) and labelled as G4, have even higher thermal stability (>60° C.), compared to both G3 (only PCL) and G5 (PCL-polyurethane crosslinked with IPDI). FIG. 7 shows further improvement in melting point up to 58° C. when formulation G5 with PCL-polyurethane matrix is annealed for 48 hours at 49 C. The detailed formulation composition for each formulation (G3-G5) is listed in Table 3. Each of the granule samples were placed in a conventional lab oven where the temperature was maintained at 55° C. and 60

TABLE 3
Compositions of G3, G4, and G5 Formulations

| Sample Name | G3 | G4 | G5 |
|---|---|---|---|
| Granule dimension | 3 mm × 3 mm | 3 mm × 3 mm | 3 mm × 3 mm |
| Additives | BHT and TBHQ | BHT and TBHQ | BHT and TBHQ |
| Polymer - Filler type | PCL and 70 C. | PCL and 70 C. | PCL and 70 C. |
| UV blocker | Octabenzone + | Octabenzone + | Octabenzone + |
| | Kenawax | Kenawax | Kenawax |
| TGAI Loading | 33% | 33% | 33% |
| Active ingredients | Z9-14 AC and | Z9-14 AC and | Z9-14 AC and |
| | Z11-16 Ac | Z11-16 Ac | Z11-16 Ac |
| Crosslinker | N/A | 1.5% Hexamethylene | 1.5% Isophorone |
| | | diisocyanate | diisocyanate |

### Lab Release Assay for PCL-Polyurethane Matrices

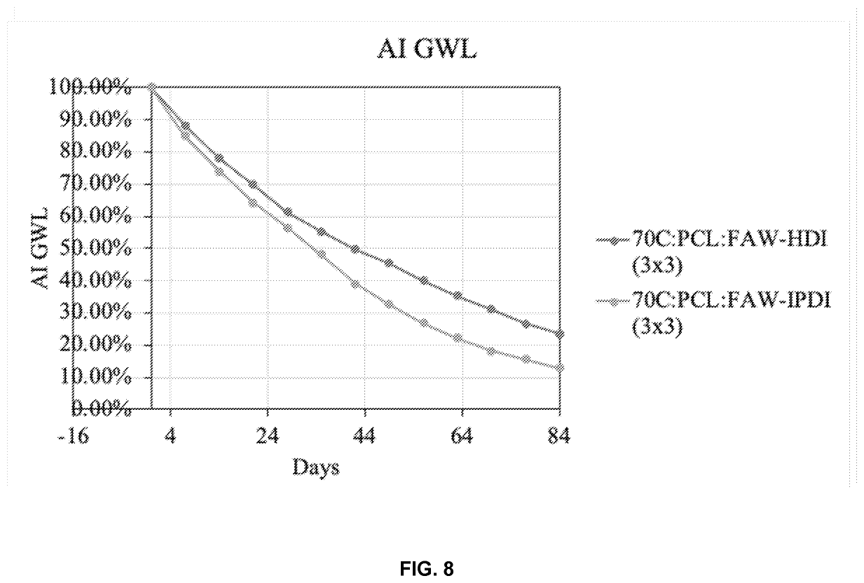

Granules including the PCL-polyurethane matrices were evaluated in an environmental chamber to determine their FAW blend release properties (FIG. 8). The active ingredient was released over an 84 day period at 40 C and 50 RH %

### Moth Capture

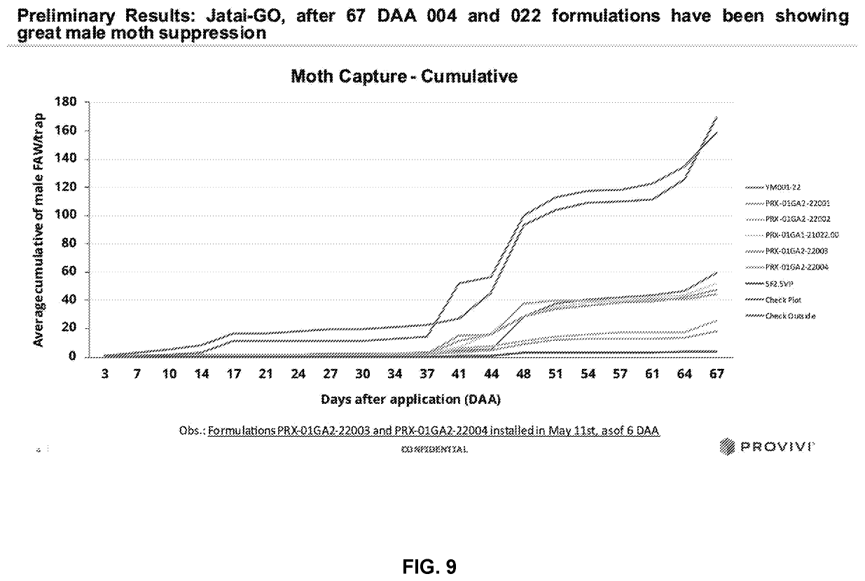

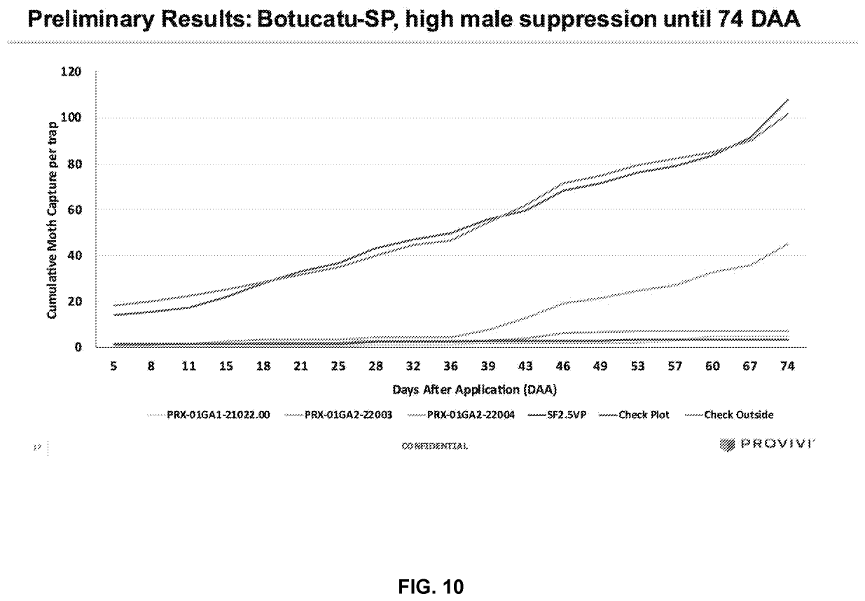

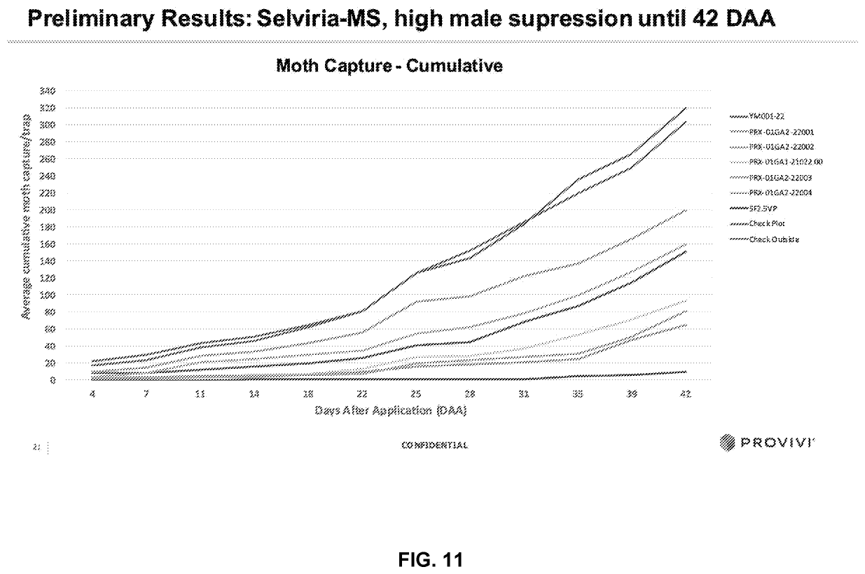

Mating disruption results of PCL-polyurethane biodegradable matrices (G4 and G5 with hexamethylene diisocyanate and isophorone diisocyanate, respectively) are shown in FIGS. 9-11. The granules including PCL-polyurethane biodegradable matrices reduced male moth capture until 67 days after application (DAA) (FIG. 9), 74 DAA (FIG. 10), and 42 DAA (FIG. 11).

What is claimed is:

1. A controlled-release agrochemical composition comprising:
a crosslinked matrix; and
a semiochemical composition contained within the crosslinked matrix.

2. The composition of claim 1, wherein the melting point of the composition is greater than 50° C.

3. The composition of any one of claims 1-2, wherein the composition is prepared by a process comprising reacting:
a first mixture comprising a hydroxy- or amine-containing biodegradable polymer and
a second mixture comprising crosslinking monomer and the semiochemical composition.

4. The composition of claim 3, further comprising mixing the first mixture and the second mixture to form a third mixture and then, extruding the third mixture to form the dispenser.

5. The composition of claim 3, further comprising combining the first mixture with the second mixture and then, extruding the combined first mixture and second mixture to form the dispenser.

6. The composition of any one of claims 3-5, wherein the second mixture further comprises a chain extender.

7. The composition of claim 6, wherein the chain extender comprises polypropylene glycol, 1,4-butanediol, ethylene glycol, 1,6-hexanediol, diethylene glycol, diethyltoluene diamine, propylene diamine, 1,6-hexane diamine, or a mixture thereof.

8. The composition of any one of claims 3-7, wherein the second mixture further comprises a catalyst.

9. The composition of claim 8, wherein the catalyst comprises triethylene diamine (TEDA), dimethylpiperazine (DMP), dimethylethanolamine (DMEA), and diazabicyclooctane (DABCO), dibutyltin dilaurate (DBTL), or a mixture thereof.

10. The composition of any one of claims 3-9, wherein the second mixture further comprises an antioxidant.

11. The composition of any one of claims 1-10, wherein the crosslinked matrix comprises about 0.01% to about 5% by weight of an antioxidant.

12. The composition of any one of claims 3-11, wherein the second mixture further comprises a UV-blocking agent.

13. The composition of claim 12, wherein the UV-blocking agent comprises methyl cinnamate, iron oxides, carbon black, octabenzone, avobenzone or a mixture thereof.

14. The composition of claims 1-13 further comprising a dye such as Pigment Blue 15:3, CI Yellow 1, solvent green 3 and Kenawax.

15. The composition of any one of claims 3-14, wherein the dispenser further comprises an anticaking agent.

16. The composition of claim 15, wherein the anticaking agent is charcoal, amorphous silica, fumed silica, or a mixture thereof.

17. The composition of claim 1-16, wherein the composition comprises about 0 wt % to about 2 wt % of an anticaking agent.

18. The composition of any one of claim 3-17, wherein the biodegradable polymer is a polyester.

19. The composition of claim 18, wherein the polyester is polycaprolactone (PCL), poly(butylene adipate-co-terephthalate) (PBAT), polybutylene succinate (PBS), polyhydroxyalkanoate (PHA), polylactic acid (PLA), or a mixture thereof.

20. The composition of claim 18, wherein the polyester is PCL.

21. The composition of any one of claims 3-19, wherein the crosslinking monomer comprises a diisocyanate, a triisocyanate, or a mixture thereof.

22. The composition of claim 21, wherein the crosslinking monomer is an aliphatic or aromatic crosslinking monomer.

23. The composition of claim 21, wherein the crosslinking monomer is hexamethylene diisocyanate, isophorone diisocyanate, 2,6-toluene diisocyanate, 2,4-toluene diisocyanate, 1,5-naphthylene diisocyanate, 4,4′-diphenylmethane diisocyanate, 2,4-toluenediisocyanate trimer, hexamethylene diisocyanate trimer, or a mixture.

24. The composition of claim 21, wherein the crosslinking monomer is hexamethylene diisocyanate, isophorone diisocyanate, or a mixture thereof.

25. The composition of any one of claims 3-24, wherein the crosslinked matrix comprises about 0.2% to about 5.0% by weight of the crosslinking monomer.

26. The composition of any one of claims 1-25, further comprising a filler contained within the crosslinked matrix.

27. The composition of claim 26, wherein the filler is selected from the group consisting of a clay (including organoclay), a zeolite, talcum, shredded hay, cotton, cork, hemp, wood chips, wood dust, wood excelsior, microcrystalline cellulose, paper pulp, kaolin, calcined kaolin, cyclodextrin, chitosan, or mixtures thereof.

28. The composition of claim 26, wherein the filler is a biomass from a fermentation.

29. The composition of any one of claims 26-28, wherein the filler is an active filler (i.e., a filler that retains the semiochemical).

30. The composition of any one of claims 26-29, wherein the composition comprises about 1 wt % to about 80 wt % of filler.

31. The composition of any one of claims 1-30, wherein the composition comprises 0.0001% to 40%, by weight, the semiochemical composition.

32. The composition of any one of claims 1-31, wherein the composition is a dispenser in the shape of a cylindrical disc or rectangular prism.

33. The composition of claim 32, wherein the surface area of the dispenser is from about 10 cm² to about 300 cm²

34. The composition of claim 32, wherein the surface area of the dispenser is from about 1 cm² to about 100 cm².

35. The composition of claim 32, wherein the thickness of the dispenser is from about 0.1 mm to about 10 mm.

36. The composition of claim 32, wherein the thickness of the dispenser is from about 0.1 mm to about 4 mm.

37. The composition of claim 32, wherein the thickness of the dispenser is from about 1 mm to about 10 mm.

38. The composition of any one of claims 1-37, wherein the semiochemical composition is selected from the group consisting of an allomone, a kairomone, a pheromone, or mixtures thereof.

39. The composition of any one of claims 1-38, wherein the semiochemical composition comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-9-Tetradecenyl acetate (Z9-14Ac), (Z)-11-Tetradecenyl acetate (Z11-14Ac), (Z)-11-Hexradecenyl acetate (Z11-16Ac) (E)-5-Decenyl acetate (E5-10Ac), (E,E)-8,10-Decadienyl acetate (E8E10-10Ac), (Z)-11-Hexadecenyl acetate (Z11-16Ac), or mixtures thereof.

40. The composition of any one of claims 1-38, wherein the semiochemical composition comprises (Z)-9-Hexadecenal (Z9-16Ald), (Z)-11-Hexadecenal (Z11-16Ald), (Z)-13-Octadecenal (Z13-18Ald), and (Z)-9-Octadecenal (Z9-18Ald).

41. The composition of any one of claims 1-38, wherein the semiochemical composition comprises (Z)-9-Tetradecenyl Acetate (Z9-14Ac) and (Z)-11-Hexadecenyl Acetate (Z11-16Ac).

42. The composition of claim 41, wherein the semiochemical composition comprises about 87 wt % of (Z)-9-Tetradecenyl Acetate (Z9-14Ac) and about 13 wt % of (Z)-11-Hexadecenyl Acetate (Z11-16Ac).

43. The dispenser of claim 41, wherein the semiochemical composition comprises about 94 wt % of (Z)-9-Tetradecenyl Acetate (Z9-14Ac), about 4 wt % of (Z)-7-dodecenyl Acetate (Z7-12Ac), and about 2 wt % of (Z)-11-Hexadecenyl Acetate (Z11-16Ac).

44. The composition of any one of claims 1-43, wherein the composition comprises about 1% to about 50% by weight of the semiochemical composition.

45. The composition of any one of claims 1-44, wherein the composition comprises about 1 mg to about 5 g of the semiochemical composition.

46. The composition of any one of claims 1-45, wherein the composition releases from 0.15 g/Ha to 4 g/Ha of the semiochemical per day after installation in a field.

47. The composition of any one of claims 1-46, wherein the composition releases the semiochemical for at least about a month after installation in a field.

48. A controlled-release agrochemical flake comprising
a crosslinked matrix; and
a semiochemical composition contained within the crosslinked matrix.

49. A controlled-release agrochemical granule comprising:
a crosslinked matrix; and
a semiochemical composition contained within the crosslinked matrix.

50. The granule of claim 49, wherein the shape of the granule is a cylinder, cube, sphere, irregular 3d object, or a mixture thereof.

51. The granule of any one of claims 49-50, wherein the mean dimension of the granule is from about 0.1 mm to about 10 mm.

52. The granule of any one of claims 49-51, wherein the mean volume of the granule is from about 0.001 mm³ to about 1000 mm³.

53. A controlled-release agrochemical dispenser comprising the flakes of claim 48 or the granules of any one of claims 49-52 contained in a sachet.

54. A controlled-release agrochemical dispenser comprising the flakes claim 48 or the granules of any one of claims 49-52 joined together by a glue.

55. A method of controlling a lepidopteran pest, the method comprising applying an effective amount of the controlled-release agrochemical dispenser of any one of claims 1-47, the flake of claim 48 or the granule of any one of claims 49-52 to a corn field.

56. The method of claim 55, wherein the application rate is from about 10 g a.i./ha to about 150 g a.i./ha.

57. The method of any one of claims 55-56, wherein the method controls FAW for about 60 days following application.

58. The method of any one of claims 55-56, wherein the method controls lepidopteran pest for about 60 days following application.

59. A method of controlling yellow rice stemborer in rice, the method comprising applying an effective amount of the controlled-release agrochemical dispenser of any one of claims 1-48, the flake of claim 49 or the granule of any one of claims 50-53 to a rice paddy field.

60. The method of claim 59, wherein the method controls yellow rice stemborer for about 60 days following application.

61. A process for making a controlled-release agrochemical dispenser, flake or granule, the method comprising reacting:
a first mixture comprising a hydroxy- or amine-containing biodegradable polymer and
a second mixture comprising crosslinking monomer and the semiochemical composition.

62. The process of claim 61, wherein the reaction is conducted by twin-screw extrusion.
